(19) United States
(12) Patent Application Publication
(10) Pub. No.: US 2025/0029627 A1
(43) Pub. Date: Jan. 23, 2025

(54) METHOD AND APPARATUS FOR PROCESSING AUDIO DATA, DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventors: Huanbin ZOU, Shenzhen (CN); Zhicheng LI, Shenzhen (CN); Jun ZHAO, Shenzhen (CN)

(21) Appl. No.: 18/908,353

(22) Filed: Oct. 7, 2024

Related U.S. Application Data
(63) Continuation of application No. PCT/CN2023/129766, filed on Nov. 3, 2023.

(30) Foreign Application Priority Data
Dec. 30, 2022 (CN) 202211725937.6

(51) Int. Cl. G10L 21/0232; G10L 21/0264; G10L 25/18; G10L 25/60

(52) U.S. Cl. CPC G10L 21/0232; G10L 21/0264; G10L 25/18; G10L 25/60

(57) ABSTRACT

Embodiments of the present disclosure disclose a method and an apparatus for processing audio data, a device, and a storage medium, applied to a cloud server in cloud technologies. The method includes: obtaining original noise audio data to be processed and a target scenario parameter associated with the original noise audio data; determining, based on the target scenario parameter, a target noise reduction strength parameter for noise reduction processing; and performing noise reduction processing on the original noise audio data based on the target noise reduction strength parameter, to obtain target enhanced audio data.

### CROSS-REFERENCES TO RELATED APPLICATIONS

This application is a continuation application of PCT Patent Application No. PCT/CN2023/129766, filed on Nov. 3, 2023, which claims priority to China Patent Application No. 202211725937.6, filed on Dec. 30, 2022, both of which are incorporated herein by reference in their entirety.

### FIELD OF THE TECHNOLOGY

The present disclosure relates to the field of cloud technologies, and in particular, to a method and an apparatus for processing audio data, a device, a computer-readable storage medium, and a computer program product.

### BACKGROUND OF THE DISCLOSURE

Currently, communication systems such as a voice over internet protocol (VOIP) communication system and a cellular communication are commonly used in a plurality of communication scenarios such as internet call, network conference, and live streaming. Because of complex and diverse environments of speakers, collected audio data generally includes noise data. Therefore, denoising processing needs to be performed on noisy audio data (namely, the audio data including the noise data), to ensure quality of the audio data. Currently, in a process of performing denoising processing on the noisy audio data, the noise data needs to be completely separated from pure audio data (namely, valid voice data), to remove noise. In practice, it is found that certain loss may occur to the pure audio data in such a denoising processing manner, which causes poor quality of the valid audio data.

### SUMMARY

Embodiments of the present disclosure provide a method and an apparatus for processing audio data, a device, a computer-readable storage medium, and a computer program product, which can avoid loss of valid audio data during noise reduction, so that quality of the audio data is improved.

An embodiment of the present disclosure provides a method for processing audio data, applied to a computer device, including: obtaining original noise audio data to be processed, and a target scenario parameter associated with the original noise audio data; determining, based on the target scenario parameter, a target noise reduction strength parameter for noise reduction processing; and performing noise reduction processing on the original noise audio data based on the target noise reduction strength parameter, to obtain target enhanced audio data.

An embodiment of the present disclosure provides an apparatus for processing audio data, including: an obtaining module, configured to obtain original noise audio data to be processed, and a target scenario parameter associated with the original noise audio data; a determining module, configured to determine, based on the target scenario parameter, a target noise reduction strength parameter for noise reduction processing; and a processing module, configured to perform noise reduction processing on the original noise audio data based on the target noise reduction strength parameter, to obtain target enhanced audio data.

An embodiment of the present disclosure provides a computer device, including a memory and a processor, the memory having a computer program stored therein, and the processor, when executing the computer program, implementing the operations of the method for processing audio data.

According to an aspect of an embodiment of the present disclosure, a non-transitory computer-readable storage medium is provided, having a computer program stored therein, the computer program, when executed by a processor, implementing the operations of the method for processing audio data.

In the embodiments of the present disclosure, a target noise reduction strength parameter configured for performing noise reduction processing on original noise audio data is adaptively determined based on a target scenario parameter associated with the original noise audio data, and noise content in the original noise audio data is quantitatively reduced based on the target noise reduction strength parameter. To be specific, the target scenario parameter reflects at least one of an application scenario and a collection scenario of the original noise audio data, and the target noise reduction strength parameter reflects a strength of suppressing noise in the original noise audio data. In other words, an actual requirement for the audio data in the application scenario of the original noise audio data (and/or noise distribution in the collection scenario of the original noise audio data) is used to quantitatively reduce the noise content in the original noise audio data, and accept a certain level of noise residuals. There is no need to completely separate the noise data and the audio data in the original noise audio data, to completely suppress the noise, avoid loss of effective audio data during noise reduction, improve quality of the audio data, and improve flexibility of noise processing.

### BRIEF DESCRIPTION OF THE DRAWINGS

To describe the technical solutions of the embodiments of the present disclosure or the related art more clearly, the following briefly introduces the accompanying drawings required for describing the embodiments or the related art. Apparently, the accompanying drawings in the following description show only some embodiments of the present disclosure, and a person of ordinary skill in the art may still derive other drawings from these accompanying drawings without creative efforts.

FIG. 1 is a schematic diagram of a system for processing audio data according to the present disclosure.

FIG. 2 is a schematic diagram of an interaction scenario of a method for processing audio data according to the present disclosure.

FIG. 3 is a schematic flowchart of a method for processing audio data according to the present disclosure.

FIG. 4 is a schematic flowchart of a method for processing audio data according to the present disclosure.

FIG. 5 is a schematic diagram of a structure of a target noise reduction processing model according to the present disclosure.

FIG. 6 is a schematic diagram of perceptual evaluation of speech quality (PESQ) scores of noise audio data under different noise reduction strength parameters according to the present disclosure.

FIG. 7 is a schematic diagram of scale-invariant signal-to-noise ratio (SI-SNR) scores of noise audio data under different noise reduction strength parameters according to the present disclosure.

FIG. 8 is a schematic diagram of a structure of an apparatus for processing audio data according to an embodiment of the present disclosure.

FIG. 9 is a schematic diagram of a structure of a computer device according to an embodiment of the present disclosure.

### DESCRIPTION OF EMBODIMENTS

The following clearly and completely describes the technical solutions in the embodiments of the present disclosure with reference to the accompanying drawings in the embodiments of the present disclosure. Apparently, the described embodiments are only some of the embodiments of the present disclosure rather than all of the embodiments. All other embodiments obtained by a person of ordinary skill in the art based on the embodiments of the present disclosure without creative efforts shall fall within the protection scope of the present disclosure.

The embodiments of the present disclosure mainly relate to an artificial intelligence cloud service. The artificial intelligence cloud service is also generally referred to as an AI as a Service (AIaaS). The AIaaS is currently a mainstream service method of an artificial intelligence platform. An AIaaS platform splits several common AI services, and provides an independent or packaged service in a cloud. This service mode is similar to opening an AI theme marketplace. To be specific, all developers can access, through an API interface, one or more AI services provided by the platform. Some capitalized developers can also use an AI framework and an AI infrastructure provided by the platform to deploy, operate, and maintain proprietary cloud artificial intelligence services.

For example, the artificial intelligence cloud service includes a target noise reduction processing model configured to perform noise reduction processing on noise audio data. When noise reduction processing needs to be performed on original noise audio data, a computer device may invoke the target noise reduction processing model in the artificial intelligence cloud service through the API interface, and input the original noise audio data and a target noise reduction strength parameter into the target noise reduction processing model. Noise reduction processing is performed on the original noise audio data based on the target noise reduction strength parameter by using the target noise reduction processing model, to quantitatively reduce noise content in the original noise audio data, avoid a loss of valid audio data during noise reduction, improve quality of the audio data, and achieve more intelligent noise reduction processing on the audio data. In addition, different computer devices can invoke the target noise reduction processing model, so that a plurality of computer devices share the target noise reduction processing model, and a utilization rate of the target noise reduction processing model is improved. Therefore, the computer device does not need to separately obtain the target noise reduction processing model through training, and computing resource overheads of the computer device are reduced.

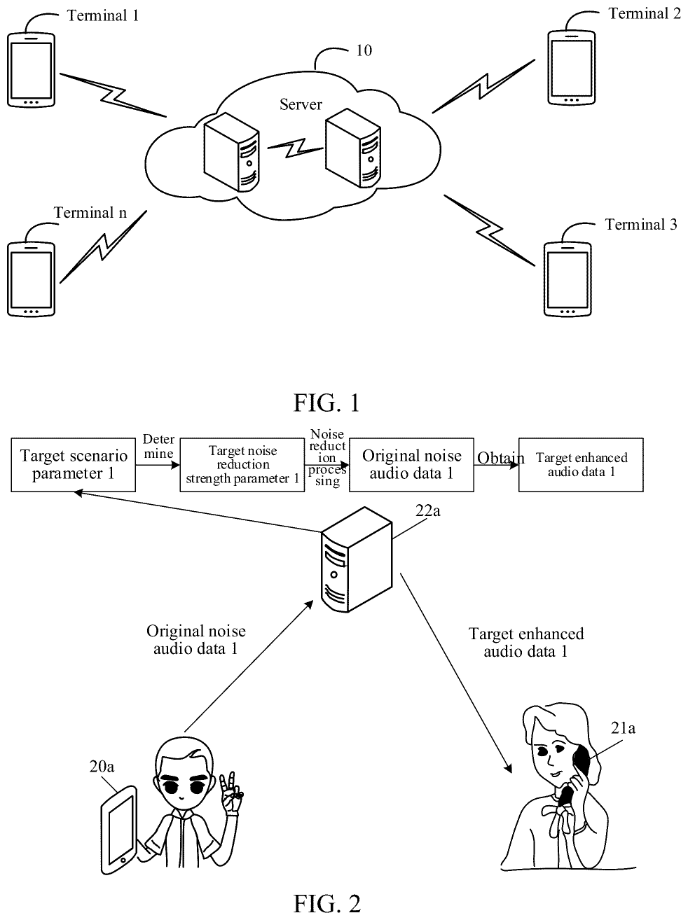

To facilitate clearer understanding of the present disclosure, a system for processing audio data implementing the present disclosure is first described. As shown in FIG. 1, the system for processing audio data includes a server 10 and a terminal cluster. The terminal cluster may include one or more terminals. A quantity of terminals is not limited herein. As shown in FIG. 1, the terminal cluster may include a terminal 1, a terminal 2, . . . , and a terminal n. The terminal 1, the terminal 2, the terminal 3, . . . , and the terminal n may all perform network connections with the server 10, so that each terminal may exchange data with the server 10 through the network connection.

One or more target applications are installed in the terminal. The target application may be an application having a voice communication function. For example, the target application includes an independent application, a web application, a mini program in a host application, or the like. Any terminal in the terminal cluster may serve as a sending terminal or a receiving terminal. The sending terminal may be a terminal that generates original noise audio data and sends the original noise audio data. The receiving terminal may be a terminal that receives the original noise audio data. For example, when a user 1 corresponding to the terminal 1 performs voice communication with a user 2 corresponding to the terminal 2, and when the user 1 needs to send audio data to the user 2, the terminal 1 may be referred to as the sending terminal, and the terminal 2 may be referred to as the receiving terminal. Similarly, when the user 2 needs to send audio data to the user 1, in this case, the terminal 2 may be referred to as the sending terminal, and the terminal 1 may be referred to as the receiving terminal.

The server 10 is a device that provides a back-end service for the target application in the terminal. In an embodiment, the server may be configured to perform noise reduction processing and the like on the original noise audio data sent by the sending terminal, and forward noise-reduced original noise audio data to the receiving terminal. In an embodiment, the server 10 may be configured to forward the original noise audio data sent by the sending terminal to the receiving terminal, and the receiving terminal performs noise reduction processing on the original noise audio data, to obtain processed original noise audio data. In an embodiment, the server may be configured to receive noise-reduced original noise audio data sent by the sending terminal, and forward the noise-reduced original noise audio data to the receiving terminal. In other words, the noise-reduced original noise audio data is obtained by the sending terminal performing noise reduction processing on the original noise audio data.

In some embodiments, the original noise audio data in this embodiment of the present disclosure may refer to audio data collected by a microphone of the sending terminal. In other words, the original noise audio data refers to audio data on which noise reduction processing is not performed. Generally, the original noise audio data includes audio data and noise data. The audio data may refer to data useful to a user. For example, the audio data may refer to voice data in a voice communication process of the user, or the audio data may refer to a music piece recorded by the user. The audio data may be obtained by collecting sound made by humans, animals, robots, and the like. The noise data may refer to data meaningless to the user. For example, the noise data may refer to environmental noise. For example, during voice communication of the user, audio data other than the voice data of both call parties is the noise data.

In some embodiments, the server may be an independent physical server, or a server cluster or a distributed system including at least two physical servers, or may be a cloud server that provides a cloud service, a cloud database, cloud computing, a cloud function, cloud storage, a network service, cloud communication, a middleware service, a domain name service, a security service, a content delivery network (CDN), and a basic cloud computing service such as big data or an artificial intelligence platform. The terminal may be a vehicle-mounted terminal, a smartphone, a tablet computer, a notebook computer, a desktop computer, a smart speaker, a screen speaker, a smartwatch, or the like, but is not limited. The terminals and the server may be connected directly or indirectly in a wired or wireless communication manner. In addition, there may be one or at least two terminals and servers. This is not limited in the present disclosure.

The system for processing audio data in FIG. 1 may be used in a voice communication scenario, a live broadcast scenario, an audio and video recording scenario, or the like. An example in which the system for processing audio data in FIG. 1 is used in a voice communication scenario shown in FIG. 2 is used for description. A terminal 20a in FIG. 2 may be any terminal in the terminal cluster in FIG. 1, a terminal 21a in FIG. 2 may be any terminal other than the terminal 20a in the terminal cluster in FIG. 1, and a server 22a in FIG. 2 may be the server 10 in FIG. 1.

When a user 1 corresponding to the terminal 20a performs voice communication with a user 2 corresponding to the terminal 21a, the terminal 20a may perform collection on a speaking process of the user 1, to obtain original noise audio data 1. The original noise audio data 1 includes speech content (that is, voice data 1) of the user 1 and noise data 1. The noise data 1 reflects environmental noise during speaking of the user 1, such as howling made by the terminal 20a, or speech content of other people. After collecting the original noise audio data 1, the terminal 20a may send the original noise audio data 1 to the server 22a. After receiving the original noise audio data 1, the server 22a may obtain a target scenario parameter 1 of the original noise audio data 1. The target scenario parameter 1 may be configured for reflecting at least one of a collection scenario or an application scenario of the original noise audio data 1. An example in which the target scenario parameter 1 reflects the application scenario of the original noise audio data 1 is used for description. The target scenario parameter 1 reflects that the application scenario of the original noise audio data 1 is the voice communication scenario. The server 22a may query, based on a correspondence between an application scenario and a noise reduction strength parameter, a noise reduction strength parameter corresponding to the application scenario of the original noise audio data 1, and determine the queried noise reduction strength parameter as a target noise reduction strength parameter 1 corresponding to the original noise audio data 1.

The target noise reduction strength parameter 1 reflects a strength of noise reduction processing that needs to be performed on noise data in the original noise audio data 1. Therefore, the server 22a may perform noise reduction processing on the original noise audio data 1 based on the target noise reduction strength parameter 1, to obtain target enhanced audio data 1, and send the target enhanced audio data 1 to the terminal 21a. Some noise data remains in the target enhanced audio data 1, to avoid damage to the audio data in the original noise audio data 1 caused by completely separating the audio data and the noise data of the original noise audio data 1. After the terminal 21a receives the target enhanced audio data 1, the user 2 may perceive an environment of the user 1 based on the target enhanced audio data 1, to achieve a more realistic and full voice communication process.

Similarly, when the user 1 corresponding to the terminal 20a performs voice communication with the user 2 corresponding to the terminal 21a, the terminal 21a may perform collection on a speaking process of the user 2, to obtain original noise audio data 2. The original noise audio data 2 includes speech content (that is, voice data 2) of the user 2 and noise data 2. The noise data 2 reflects environmental noise during speaking of the user 2, such as howling made by the terminal 21a, or speech content of other people. After collecting the original noise audio data 2, the terminal 21a may send the original noise audio data 2 to the server 22a. After receiving the original noise audio data 2, the server 22a may obtain a target scenario parameter 2 of the original noise audio data 2. The target scenario parameter 2 may be configured for reflecting at least one of a collection scenario or an application scenario of the original noise audio data 2. An example in which the target scenario parameter 2 reflects the application scenario of the original noise audio data 2 is used for description. The target scenario parameter 2 reflects that the application scenario of the original noise audio data 2 is the voice communication scenario. The server 22a may query, based on a correspondence between an application scenario and a noise reduction strength parameter, a noise reduction strength parameter corresponding to the application scenario of the original noise audio data 2, and determine the queried noise reduction strength parameter as a target noise reduction strength parameter 2 corresponding to the original noise audio data 2.

The target noise reduction strength parameter 2 reflects a strength of noise reduction processing that needs to be performed on noise data in the original noise audio data 2. Therefore, the server 22a may perform noise reduction processing on the original noise audio data 2 based on the target noise reduction strength parameter 2, to obtain target enhanced audio data 2, and send the target enhanced audio data 2 to the terminal 20a. Some noise data remains in the target enhanced audio data 2, to avoid damage to the audio data in the original noise audio data 2 caused by completely separating the audio data and the noise data of the original noise audio data 2. After the terminal 20a receives the target enhanced audio data 2, the user 1 may perceive an environment of the user 2 based on the target enhanced audio data 2, to achieve a more realistic and full voice communication process.

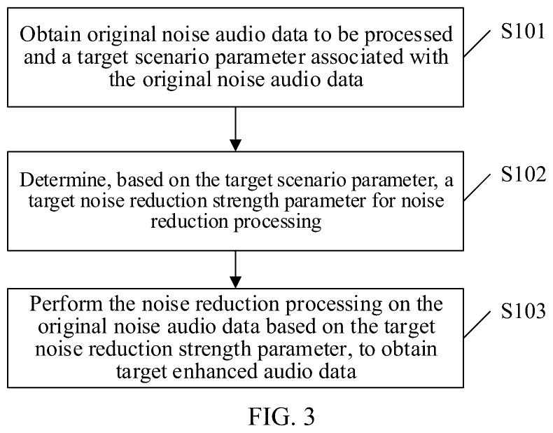

In some embodiments, FIG. 3 is a schematic flowchart of a method for processing audio data according to an embodiment of the present disclosure. As shown in FIG. 3, the method may be performed by any terminal in the terminal cluster in FIG. 1, or may be performed by the server in FIG. 1. In the embodiments of the present disclosure, a device configured to perform the method for processing audio data may be collectively referred to as a computer device. The method may include the following operations.

Operation 101: Obtain original noise audio data to be processed and a target scenario parameter associated with the original noise audio data. The original noise audio data may be understood as original audio data that contains noise.

In some embodiments, the computer device may collect the original noise audio data to be processed, or the computer device may obtain the original noise audio data to be processed from another device, and then obtain the target scenario parameter associated with the original noise audio data. The target scenario parameter is configured for determining at least one of a collection scenario or an application scenario of the original noise audio data.

In an embodiment, the computer device may detect a recording environment of the original noise audio data through a sensor, to obtain an environmental parameter of the recording environment, and determine the environmental parameter of the recording environment as the target scenario parameter of the original noise audio data. The environmental parameter of the recording environment includes one or more of light, a temperature, humidity, and the like, that is, the target scenario parameter includes the environmental parameter of the recording environment. The target scenario parameter may be configured for determining the collection scenario of the original noise audio data. For example, if the light in the recording environment is natural light, it indicates that the collection scenario of the original noise audio data is an outdoor place. If the light in the recording environment is artificial light, it indicates that the collection scenario of the original noise audio data is an indoor place.

In an embodiment, the computer device may obtain position information of a collection device of the original noise audio data, determine the position information of the collection device as position information of a collection environment of the original noise audio data, and determine the position information of the collection environment as the target scenario parameter of the original noise audio data. The target scenario parameter may be configured for determining the collection scenario of the original noise audio data. For example, if it is determined, based on position information of the recording environment, that the recording environment is a park, it indicates that the collection scenario of the original noise audio data is an outdoor place or an open place. If it is determined, based on the position information of the recording environment, that the recording environment is an office building, it indicates that the collection scenario of the original noise audio data is an indoor place, a private place, or the like.

In an embodiment, the computer device may obtain a program identifier corresponding to a recording application of the original noise audio data, and determine the program identifier of the recording application as the target scenario parameter of the original noise audio data. The recording application may include, but is not limited to, a voice call application, a conference application, a music playing application, and the like. The program identifier may be a program name, a number, or the like. The target scenario parameter may be configured for determining the application scenario of the original noise audio data. For example, if the program identifier of the recording application indicates that the recording application is the voice call application, it indicates that the application scenario of the original noise audio data is a voice call scenario. If the program identifier of the recording application indicates that the recording application is the conference application, it indicates that the application scenario of the original noise audio data is a conference application scenario.

In some embodiments, the target scenario parameter may include at least one or more of the environmental parameter of the recording environment of the original noise audio data, the position information of the recording environment, the program identifier corresponding to the recording application, and the like.

In an embodiment, when the target scenario parameter is configured for determining the collection scenario of the original noise audio data, the computer device may determine, based on position information of a device that collects the original noise audio data, the collection scenario associated with the original noise audio data. The collection scenario includes an indoor place, an outdoor place, a private place, an open place, or the like. In an embodiment, when the target scenario parameter is configured for determining the application scenario of the original noise audio data, the computer device may determine the application scenario of the original noise audio data based on usage indication information of an owner of the original noise audio data. The usage indication information is configured for indicating the application scenario of the original noise audio data. The application scenario may include a voice communication scenario, a livestreaming scenario, a music work playing scenario, or the like. In an embodiment, when the target scenario parameter is configured for determining the application scenario and the collection scenario of the original noise audio data, the computer device may determine the collection scenario associated with the original noise audio data based on the position information of the device that collects the original noise audio data, and determine the application scenario of the original noise audio data based on the usage indication information of the owner of the original noise audio data.

Operation 102: Determine, based on the target scenario parameter, a target noise reduction strength parameter for noise reduction processing.

In some embodiments, the computer device may determine, based on the target scenario parameter, the target noise reduction strength parameter configured for performing noise reduction processing on the original noise audio data. The target noise reduction strength parameter is configured for indicating an amount of data (that is, content) corresponding to noise data that needs to be removed from the original noise audio data. In other words, the target noise reduction strength parameter is configured for indicating a noise reduction strength for the noise data in the original noise audio data. For example, it is assumed that intensity of the noise data in the original noise audio data is 6 dB, and the target noise reduction strength parameter is 5 dB. The target noise reduction strength parameter indicates to reduce the intensity (that is, power) of the noise data in the original noise audio data by 5 dB, and intensity of noise data in noise-reduced original noise audio data (that is, target enhanced audio data) is 1 dB. Alternatively, it is assumed that an original signal-to-noise ratio of the original noise audio data is 10 dB, and the target noise reduction strength parameter is 5 dB. The original signal-to-noise ratio of the original noise audio data is a ratio of power of audio data in the original noise audio data to power of the noise data in the original noise audio data. Therefore, reducing intensity (that is, the power) of the noise data in the original noise audio data by 5 dB is equivalent to increasing a signal-to-noise ratio of the audio data in the original noise audio data by 5 dB. In other words, a signal-to-noise ratio of noise-reduced original noise audio data (that is, target enhanced audio data) is changed to 5 dB+6 dB=11 dB. A larger target noise reduction strength parameter indicates a larger noise reduction strength for the original noise audio data and a larger amount of data corresponding to the noise data that needs to be removed from the original noise audio data. A smaller target noise reduction strength parameter indicates a smaller noise reduction strength for the original noise audio data and a smaller amount of data corresponding to the noise data that needs to be removed from the original noise audio data.

In some embodiments, the computer device may determine, in any one of the following three manners, the target noise reduction strength parameter configured for performing noise reduction processing on the original noise audio data. Manner 1: If the target scenario parameter includes the program identifier corresponding to the recording application, the computer device may determine the application scenario of the original noise audio data based on the program identifier corresponding to the recording application, that is, determine that the target scenario parameter can represent the application scenario of the original noise audio data, and obtain a quality requirement level of audio data in the application scenario. The quality requirement level reflects a quality requirement for the audio data in the application scenario. In other words, a higher quality requirement level indicates a higher quality requirement for the audio data in the application scenario, that is, a lower quality requirement level indicates a lower quality requirement for the audio data in the application scenario. Generally, a larger target noise reduction strength parameter for the original noise audio data indicates a larger amount of data corresponding to the noise data that needs to be removed from the original noise audio data, and also indicates a larger loss of the audio data in the original noise audio data. A smaller target noise reduction strength parameter for the original noise audio data indicates a smaller amount of data corresponding to the noise data that needs to be removed from the original noise audio data, and also indicates a smaller loss of the audio data in the original noise audio data. Therefore, the computer device may query, based on a correspondence between the quality requirement level and a noise reduction strength parameter, a noise reduction strength parameter corresponding to the quality requirement level corresponding to the original noise audio data, and determine the queried noise reduction strength parameter as the target noise reduction strength parameter configured for performing noise reduction processing on the original noise audio data. The correspondence between the quality requirement level and the noise reduction strength parameter may be obtained based on historical experience, and the quality requirement level has a negative correlation with the target noise reduction strength parameter. In other words, a lower quality requirement level indicates a larger target noise reduction strength parameter, and a higher quality requirement level indicates a smaller target noise reduction strength parameter. This avoids a loss of the audio data in the original noise audio data caused by excessive noise reduction processing on the original noise audio data, and improves quality of the audio data.

For example, in a video conference scenario, a user may generally accept a degree of loss of quality of the audio data, but does not accept that there is a large amount of noise data in the video conference scenario. Therefore, the computer device may determine a first quality level as a quality requirement level of the original noise audio data in the video conference scenario, and determine a first noise reduction strength parameter as the target noise reduction strength parameter configured for performing noise reduction processing on the original noise audio data, to eliminate more noise data in the video conference scenario, and avoid interference from the noise data to a video conference. In a voice communication scenario, the user generally requires high quality of the audio data, and accepts that there is noise data in the voice communication scenario. Therefore, the computer device may determine a second quality level as a quality requirement level of the original noise audio data in the video conference scenario, and determine a second noise reduction strength parameter as the target noise reduction strength parameter configured for performing noise reduction processing on the original noise audio data, to eliminate less noise data in the video conference scenario, so that the user may sense, based on residual noise data, a real environment in which both voice communication parties are located, and an immersive atmosphere is established for both the voice communication parties. The first quality level is less than the second quality level, and the first noise reduction strength parameter is greater than the second noise reduction strength parameter.

Manner 2: If the target scenario parameter includes at least one of the environmental parameter of the recording environment of the original noise audio data or the position information of the recording environment, the computer device may determine the collection scenario of the original noise audio data based on the target scenario parameter, that is, determine that the target scenario parameter reflects the collection scenario of the original noise audio data. The computer device may obtain historical noise data in a historical time period in the collection scenario. The historical time period may refer to in a near day or in a near week, or the historical time period is determined based on a current time period. For example, the current time period is 19:20:00 to 19:30:00 on December 16, and the historical time period may refer to 19:20:00 to 19:30:00 on December 15. Because a distribution feature of noise data in the historical time period in the same collection scenario is similar to a distribution feature of the noise data in the current time period, the computer device may determine, based on the historical noise data, the target noise reduction strength parameter configured for performing noise reduction processing on the original noise audio data. The target noise reduction strength parameter is determined based on the historical noise data in the collection scenario, to avoid a problem that noise residue is unstable, that is, the noise data is sometimes more, sometimes less, sometimes present, sometimes absent

The determining, based on the historical noise data, the target noise reduction strength parameter configured for performing noise reduction processing on the original noise audio data includes: The computer device may determine, from the historical noise data, a noise type and a noise change feature that correspond to noise data in the collection scenario in the historical time period. The noise type includes steady noise, non-steady noise, impulsive noise, and the like. The steady noise refers to noise whose noise intensity has a small change (generally not greater than 3 dB) and that does not change greatly over time, for example, motor noise, fan nose, another electromagnetic noise, and friction and rotation at a fixed rotation speed. The non-steady noise refers to noise whose noise intensity fluctuates over time (a sound pressure change is greater than 3 dB). A part of the noise is periodic noise, such as hammering, and a part of the noise is irregular fluctuating noise, such as traffic noise. The impulsive noise is noise formed by a single or a plurality of bursts with duration being less than 1 s. Duration needed for an original level of a sound pressure level to rise to a peak value and return to the original level is less than 500 ms, and a peak sound pressure level of the noise is greater than 40 dB. The impulsive noise is usually sudden high-intensity noise, such as noise generated by blasting or firing of a fire gun. The noise change feature refers to a change speed of intensity of the historical noise data over time. In other words, the noise change feature reflects whether the historical noise data is stable. In some embodiments, the computer device may determine, based on the noise type and the noise change feature, the target noise reduction strength parameter configured for performing noise reduction processing on the original noise audio data, and determine the target noise reduction strength parameter by using a distribution feature (that is, the noise type and the noise change feature) of the historical noise data in the collection scenario, to avoid the problem that the noise residue is unstable.

When a quantity of noise types of the historical noise data in the historical time period in the collection scenario is M, M being a positive integer greater than or equal to 1, the computer device may determine, based on noise change features corresponding to historical noise data of the M noise types respectively, M candidate noise reduction strength parameters configured for performing noise reduction processing on the original noise audio data, where historical noise data of one noise type corresponds to one candidate noise reduction strength parameter. In some embodiments, the computer device may determine the M candidate noise reduction strength parameters as the target noise reduction strength parameters. Alternatively, the computer device may perform weighted average processing (or arithmetic average processing) based on the M candidate noise reduction strength parameters, to obtain the target noise reduction strength parameter. The candidate noise reduction strength parameter corresponding to the historical noise data of the noise type may be a variable that changes with the corresponding noise change feature, or the candidate noise reduction strength parameter corresponding to the historical noise data of the noise type may be a fixed value determined based on the corresponding noise change feature. In this way, a case in which noise of all the noise types cannot be suppressed can be avoided. In addition, and a problem that noise residue is discontinuous caused by a rapid change of the noise change feature over time in the non-steady noise can be avoided. In other words, a problem of low perceptibility of the audio data because the noise data in the noise-reduced original noise audio data is sometimes more, sometimes less, sometimes present, sometimes absent is avoided. In other words, the target noise reduction strength parameter configured for performing noise reduction processing on the original noise audio data is determined based on the noise type and the noise change feature of the historical noise data, so that noise reduction processing (that is, suppression processing) is performed on noise of all the noise types in the original noise audio data. Therefore, noise residue in the noise-reduced original noise audio data is more stable and smooth, and perceptibility of the audio data in the noise-reduced original noise audio data is improved.

For example, if a noise change feature of noise data of a first noise type in the original noise audio data indicates that intensity of the noise data of the first noise type changes in a range of [5 dB, 10 dB], the computer device may determine a noise reduction strength parameter corresponding to the noise data of the first noise type based on [5 dB, 10 dB], for example, determine 3 dB as the noise reduction strength parameter corresponding to the noise data of the first noise type. Similarly, if a noise change feature of noise data of a second noise type in the original noise audio data indicates that intensity of the noise data of the second noise type changes in a range of [2 dB, 6 dB], the computer device may determine a noise reduction strength parameter corresponding to the noise data of the second noise type based on [2 dB, 6 dB], for example, determine 4 dB as the noise reduction strength parameter corresponding to the noise data of the second noise type. Then, the noise reduction strength parameter corresponding to the noise data of the first noise type and the noise reduction strength parameter corresponding to the noise data of the second noise type may be determined as the target noise reduction strength parameter configured for performing noise reduction processing on the original noise audio data. The noise reduction strength parameter corresponding to the noise data of the first noise type is configured for performing noise reduction processing on the noise data of the first noise type in the original noise audio data, and the noise reduction strength parameter corresponding to the noise data of the second noise type is configured for performing noise reduction processing on the noise data of the second noise type in the original noise audio data. A noise reduction processing order of the noise data of the first noise data type may be located before (or after) a noise reduction processing order of the noise data of the second noise data type. The noise reduction processing order of the noise data of the first noise data type is the same as the noise reduction processing order of the noise data of the second noise data type. The first noise type may be the steady noise, and the second noise type may be the non-steady noise. Alternatively, the computer device may merge the noise reduction strength parameter corresponding to the noise data of the first noise type and the noise reduction strength parameter corresponding to the noise data of the second noise type, to obtain the target noise reduction strength parameter configured for performing noise reduction processing on the original noise audio data. The merging processing may be summation processing, averaging processing, or the like.

Manner 3: If the target scenario parameter includes the program identifier corresponding to the recording application and the environmental parameter of the recording environment of the original noise audio data and/or the position information of the recording environment, the computer device may determine the application scenario of the original noise audio data based on the program identifier corresponding to the recording application, and determine the collection scenario of the original noise audio data based on at least one of the environmental parameter of the recording environment of the original noise audio data or the position information of the recording environment, that is, determine that the target scenario parameter reflects the collection scenario and the application scenario of the original noise audio data. The computer device may obtain a quality requirement level of audio data in the application scenario, and determine, based on the quality requirement level, a first noise reduction strength parameter configured for performing noise reduction processing on the original noise audio data. Then, the computer device obtains historical noise data in a historical time period in the collection scenario, and determine, based on the historical noise data, a second noise reduction strength parameter configured for performing noise reduction processing on the original noise audio data. For an implementation process of determining the first noise reduction strength parameter, refer to the foregoing manner 1. For an implementation process of determining the second noise reduction strength parameter, refer to the foregoing manner 2. Then, averaging processing is performed on the first noise reduction strength parameter and the second noise reduction strength parameter, to obtain the target noise reduction strength parameter configured for performing noise reduction processing on the original noise audio data. Alternatively, the computer device may determine the first noise reduction strength parameter and the second noise reduction strength parameter as the target noise reduction strength parameter configured for performing noise reduction processing on the original noise audio data. In other words, the target noise reduction strength parameter includes the first noise reduction strength parameter and the second noise reduction strength parameter. In comprehensive consideration of the collection scenario and the application scenario of the original noise audio data, the target noise reduction strength parameter configured for performing noise reduction processing on the original noise audio data is determined, to improve accuracy of performing noise reduction processing on the original noise audio data.

In some embodiments, when the target noise reduction strength parameter includes the first noise reduction strength parameter and the second noise reduction strength parameter, a processing order corresponding to the first noise reduction strength parameter is located before a processing order corresponding to the second noise reduction strength parameter. To be specific, the computer device may first perform noise reduction processing on the original noise audio data by using the first noise reduction strength parameter, to obtain first candidate enhanced audio data, and then perform noise reduction processing on the first candidate enhanced audio data by using the second noise reduction strength parameter, to obtain the target enhanced audio data. The processing order corresponding to the first noise reduction strength parameter may be located after the processing order corresponding to the second noise reduction strength parameter. To be specific, the computer device may first perform noise reduction processing on the original noise audio data by using the second noise reduction strength parameter, to obtain second candidate enhanced audio data, and then perform noise reduction processing on the second candidate enhanced audio data by using the first noise reduction strength parameter, to obtain the target enhanced audio data. Alternatively, the processing order corresponding to the first noise reduction strength parameter is the same as the processing order corresponding to the second noise reduction strength parameter. To be specific, the computer device may perform noise reduction processing on the original noise audio data by using both the first noise reduction strength parameter and the second noise reduction strength parameter, to obtain the target enhanced audio data.

Operation 103: Perform noise reduction processing on the original noise audio data based on the target noise reduction strength parameter, to obtain target enhanced audio data.

In some embodiments, the computer device may perform noise reduction processing on the original noise audio data based on the target noise reduction strength parameter, to obtain the target enhanced audio data. In other words, the target enhanced audio data is the noise-reduced original noise audio data. Intensity of noise data in the target enhanced audio data is lower than intensity of the noise data in the original noise audio data. In addition, stability of the noise data in the target enhanced audio data is higher than stability of the noise data in the original noise audio data. In other words, the noise data in the target enhanced audio data is more stable and smooth, which is beneficial for the user to perceive audio data (that is, voice data) in the target enhanced audio data.

In some embodiments, the target noise reduction strength parameter configured for performing noise reduction processing on the original noise audio data is adaptively determined based on the target scenario parameter associated with the original noise audio data, and noise content in the original noise audio data is quantitatively reduced based on the target noise reduction strength parameter. To be specific, the target scenario parameter reflects at least one of the application scenario or the collection scenario of the original noise audio data, and the target noise reduction strength parameter reflects a strength of suppressing noise in the original noise audio data. In other words, the noise content in the original noise audio data is quantitatively reduced based on an actual requirement for the audio data in the application scenario of the original noise audio data (and/or noise distribution in the collection scenario of the original noise audio data), and a degree of noise residue is accepted. There is no need to completely separate the noise data and the audio data of the original noise audio data, to completely suppress the noise. This avoids a loss of valid audio data during noise reduction, improves quality of the audio data, and improves flexibility of noise processing.

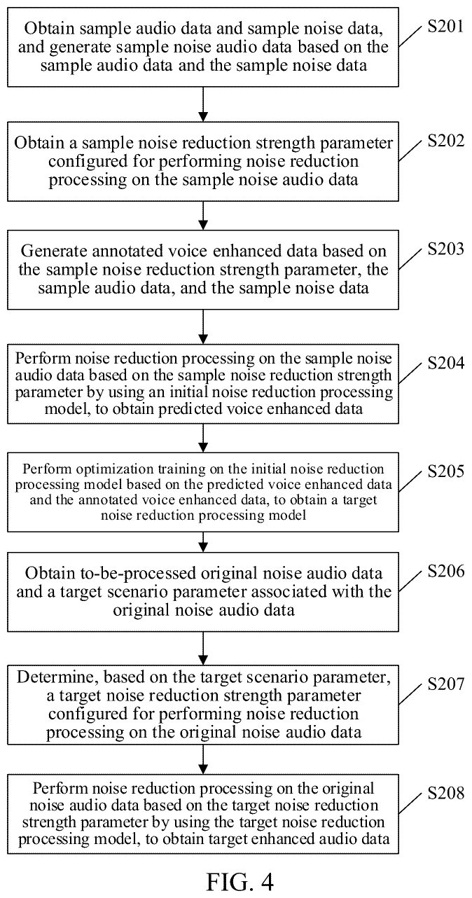

In some embodiments, FIG. 4 is a schematic flowchart of a method for processing audio data according to an embodiment of the present disclosure. As shown in FIG. 4, the method may be performed by any terminal in the terminal cluster in FIG. 1, or may be performed by the server in FIG. 1. In the embodiments of the present disclosure, a device configured to perform the method for processing audio data may be collectively referred to as a computer device. The method may include the following operations.

In this embodiment of the present disclosure, operation 201 to operation 205 are a process of performing optimization training on an initial noise reduction processing model, to obtain a target noise reduction processing model, and operation 206 to operation 208 are a process of performing noise reduction processing on original noise audio data based on a target noise reduction strength parameter by using the target noise reduction processing model.

Operation 201: Obtain sample audio data and sample noise data, and generate sample noise audio data based on the sample audio data and the sample noise data.

In this embodiment of the present disclosure, the computer device may obtain a voice data set and a noise data set. The voice data set includes a plurality of pieces of sample audio data (namely, pure voice data), and the noise data set includes a plurality of pieces of sample noise data (namely, pure noise data). Then, the sample audio data in the voice data set is combined with the sample noise data in the noise data set, to obtain a plurality of pieces of sample noise audio data.

For example, it is assumed that the sample audio data is sₙ, the sample noise data is dₙ, and the sample noise audio data is xₙ. In this case, the sample noise audio data may be represented by using the following Formula (1):

$${x}_{n} = {s}_{n} + {d}_{n} \qquad ( 1 )$$

Operation 202: Obtain a sample noise reduction strength parameter configured for performing noise reduction processing on the sample noise audio data.

In this embodiment of the present disclosure, the computer device may randomly generate the sample noise reduction strength parameter configured for performing noise reduction processing on the sample noise audio data. Alternatively, the computer device may generate, based on a noise type and a noise change feature of the sample noise data in the sample noise audio data, the sample noise reduction strength parameter configured for performing noise reduction processing on the sample noise audio data. Alternatively, the computer device may generate, based on an application scenario of the sample audio data in the sample noise audio data, the sample noise reduction strength parameter configured for performing noise reduction processing on the sample noise audio data. For an implementation process in which the computer device generates the sample noise reduction strength parameter configured for performing noise reduction processing on the sample noise audio data, refer to the foregoing implementation process of generating the target noise reduction strength parameter configured for performing noise reduction processing on the original noise audio data.

In some embodiments, the generating, based on a noise type and a noise change feature of the sample noise data in the sample noise audio data, the sample noise reduction strength parameter configured for performing noise reduction processing on the sample noise audio data includes: If a noise change feature of noise data of a first noise type in the sample noise audio data indicates that intensity of the noise data of the first noise type changes in a range of [5 dB, 10 dB], the computer device may determine a noise reduction strength parameter corresponding to the noise data of the first noise type based on [5 dB, 10 dB], for example, determine 7.5 dB as the noise reduction strength parameter corresponding to the noise data of the first noise type. Similarly, if a noise change feature of noise data of a second noise type in the sample noise audio data indicates that intensity of the noise data of the second noise type changes in a range of [2 dB, 6 dB], the computer device may determine a noise reduction strength parameter corresponding to the noise data of the second noise type based on [2 dB, 6 dB], for example, determine 3 dB as the noise reduction strength parameter corresponding to the noise data of the second noise type. Then, the noise reduction strength parameter corresponding to the noise data of the first noise type and the noise reduction strength parameter corresponding to the noise data of the second noise type may be determined as the sample noise reduction strength parameter configured for performing noise reduction processing on the sample noise audio data. The noise reduction strength parameter corresponding to the noise data of the first noise type is configured for performing noise reduction processing on the noise data of the first noise type in the sample noise audio data, and the noise reduction strength parameter corresponding to the noise data of the second noise type is configured for performing noise reduction processing on the noise data of the second noise type in the sample noise audio data. For example, the first noise type may be steady noise, and the second noise type may be non-steady noise. Alternatively, the computer device may merge the noise reduction strength parameter corresponding to the noise data of the first noise type and the noise reduction strength parameter corresponding to the noise data of the second noise type, to obtain the sample noise reduction strength parameter configured for performing noise reduction processing on the sample noise audio data. The merging processing may be summation processing, averaging processing, or the like. In some embodiments, the generating, based on an application scenario of the sample audio data in the sample noise audio data, the sample noise reduction strength parameter configured for performing noise reduction processing on the sample noise audio data includes: The computer device may obtain a quality requirement level of audio data in the application scenario of the sample audio data. The quality requirement level reflects a quality requirement for the audio data in the application scenario. In other words, a higher quality requirement level indicates a higher quality requirement for the audio data in the application scenario, that is, a lower quality requirement level indicates a lower quality requirement for the audio data in the application scenario. In some embodiments, the sample noise reduction strength parameter configured for performing noise reduction processing on the sample noise audio data is determined based on the quality requirement level. For example, a lower quality requirement level indicates a larger sample noise reduction strength parameter, and a higher quality requirement level indicates a smaller sample noise reduction strength parameter. This avoids a loss of the audio data in the sample noise audio data caused by excessive noise reduction processing on the sample noise audio data, and improves quality of the audio data.

Operation 203: Generate annotated voice enhanced data based on the sample noise reduction strength parameter, the sample audio data, and the sample noise data.

In this embodiment of the present disclosure, the sample noise reduction strength parameter is configured for suppressing the sample noise data in the sample noise audio data. Therefore, the computer device may generate the annotated voice enhanced data based on the sample noise reduction strength parameter, the sample audio data, and the sample noise data.

In some embodiments, operation 203 includes: The computer device may generate a noise reduction factor based on the sample noise reduction strength parameter, and determine a product of the noise reduction factor and the sample noise data as processed sample noise data obtained by performing noise reduction processing on the sample noise data. The noise reduction factor may be a positive number less than 1. When the sample noise reduction strength parameter is a positive number less than 1, the noise reduction factor may be the sample noise reduction strength parameter. When the sample noise reduction strength parameter is a positive number greater than 1, the noise reduction factor may be obtained by performing normalization processing on the sample noise reduction strength parameter. For example, the sample noise reduction strength parameter is δₛₙᵣ, and the noise reduction factor may be

$$1 {0}^{- \frac{{δ}_{snr}}{20}} .$$

In some embodiments, the computer device may combine (that is, perform summation processing on) the processed sample noise data and the sample audio data, to obtain the annotated voice enhanced data.

For example, it is assumed that annotated voice enhanced data is yₙ. In this case, the annotated voice enhanced data may be represented by using the following Formula (2):

$${y}_{n} = {s}_{n} + {d}_{n} \cdot {10}^{- \frac{{δ}_{s n r 1}}{20}} \qquad ( 2 )$$

In Formula (2), δₛₙᵣ₁ is the sample noise reduction strength parameter, and the annotated voice enhanced data is a target of optimization training on an initial noise reduction processing model. It can be learned from Formula (2) that the target of the optimization training on the initial noise reduction processing model is to suppress, based on the sample noise reduction strength parameter, the sample noise data in the sample noise audio data while reducing a loss of the sample audio data in the sample noise audio data.

Operation 204: Perform noise reduction processing on the sample noise audio data based on the sample noise reduction strength parameter by using an initial noise reduction processing model, to obtain predicted voice enhanced data.

In some embodiments, the computer device may input the sample noise reduction strength parameter and the sample noise audio data into the initial noise reduction processing model, and perform noise reduction processing on the sample noise audio data based on the sample noise reduction strength parameter by using the initial noise reduction processing model, to obtain the predicted voice enhanced data.

For an implementation process of performing noise reduction processing on the sample noise audio data based on the sample noise reduction strength parameter by using the initial noise reduction processing model, to obtain the predicted voice enhanced data, refer to the implementation process of performing noise reduction processing on the original noise audio data based on the target noise reduction strength parameter by using the target noise reduction processing model, to obtain the target enhanced audio data.

In some embodiments, the initial noise reduction processing model may be one of a deep neural network, a convolutional neural network, a long-short time memory network, or the like.

Operation 205: Perform optimization training on the initial noise reduction processing model based on the predicted voice enhanced data and the annotated voice enhanced data, to obtain a target noise reduction processing model.

In some embodiments, if a difference between the predicted voice enhanced data and the annotated voice enhanced data is small, it indicates that accuracy of noise reduction processing of the initial noise reduction processing model is high. If a difference between the predicted voice enhanced data and the annotated voice enhanced data is large, it indicates that accuracy of noise reduction processing of the initial noise reduction processing model is low. In other words, the predicted voice enhanced data and the annotated voice enhanced data may be configured for measuring the accuracy of noise reduction processing of the initial noise reduction processing model. Therefore, the computer device may perform optimization training on the initial noise reduction processing model based on the predicted voice enhanced data and the annotated voice enhanced data, to obtain the target noise reduction processing model, so as to improve accuracy of noise reduction processing of the target noise reduction processing model.

In some embodiments, operation 205 includes: The computer device may obtain an error function of the initial noise reduction processing model, and substitute the predicted voice enhanced data and the annotated voice enhanced data into the error function, to obtain a noise reduction processing error of the initial noise reduction processing model. The error function of the initial noise reduction processing model may be a mean square error function, a cross entropy function, or the like. The noise reduction processing error is configured for measuring the accuracy of noise reduction processing of the initial noise reduction processing model. To be specific, a larger noise reduction processing error indicates lower accuracy of noise reduction processing of the initial noise reduction processing model, and a smaller noise reduction processing error indicates higher accuracy of noise reduction processing of the initial noise reduction processing model. Then, the computer device may detect a noise change feature of intensity of noise data included in the predicted voice enhanced data, and determine stability of the noise data included in the predicted voice enhanced data based on the noise change feature of the intensity of the noise data included in the predicted voice enhanced data. The stability of the noise data included in the predicted voice enhanced data herein is configured for reflecting stability of residual noise data in the predicted voice enhanced data, and is also configured for reflecting stability of noise reduction processing of the initial noise reduction processing model. Then, the computer device may adjust a model parameter of the initial noise reduction processing model based on the noise reduction processing error and the stability, to obtain the target noise reduction processing model, so that the accuracy of noise reduction processing of the target noise reduction processing model and the stability of noise reduction processing of the target noise reduction processing model can be improved.

In some embodiments, the adjusting a model parameter of the initial noise reduction processing model based on the noise reduction processing error and the stability, to obtain the target noise reduction processing model includes: The computer device may determine a convergence status of the initial noise reduction processing model based on the noise reduction processing error. The convergence status of the initial noise reduction processing model is configured for reflecting whether the noise reduction processing error of the initial noise reduction processing model reaches a minimum value. The convergence status includes a converged state or an unconverged state. Generally, when the noise reduction processing error is less than an error threshold, the computer device may determine that the convergence status of the initial noise reduction processing model is the converged state, that is, the noise reduction processing error of the initial noise reduction processing model is the minimum value. If the noise reduction processing error is greater than or equal to the error threshold, the computer device may determine that the convergence status of the initial noise reduction processing model is the unconverged state, that is, the noise reduction processing error of the initial noise reduction processing model is greater than the minimum value. Therefore, if the convergence status of the initial noise reduction processing model is the converged state, and the stability is greater than or equal to a stability threshold, it indicates that the noise reduction processing error of the initial noise reduction processing model reaches the minimum value, or that the stability of noise reduction processing of the initial noise reduction processing model is high. In this case, there is no need to adjust the model parameter of the initial noise reduction processing model, and the computer device may determine the initial noise reduction processing model as the target noise reduction processing model. The stability threshold may be manually set, or the stability threshold may be determined based on the collection scenario of the sample noise data or the application scenario of the sample audio data. Similarly, if the convergence status of the initial noise reduction processing model is the unconverged state, or the stability is less than the stability threshold, it indicates that the noise reduction processing error of the initial noise reduction processing model does not reach the minimum value, or that the stability of noise reduction processing of the initial noise reduction processing model is poor. In this case, the computer device may adjust the model parameter of the initial noise reduction processing model based on the noise reduction processing error, and determine an adjusted initial noise reduction processing model as the target noise reduction processing model until a convergence status of the adjusted initial noise reduction processing model is the converged state, and corresponding stability is greater than or equal to the stability threshold. The model parameter of the initial noise reduction processing model is adjusted based on the stability and the convergence status, thereby helping obtain the target noise reduction processing model having high accuracy of noise reduction processing and high stability of noise reduction processing through training.

Operation 206: Obtain original noise audio data to be processed and a target scenario parameter associated with the original noise audio data.

Operation 207: Determine, based on the target scenario parameter, a target noise reduction strength parameter configured for performing noise reduction processing on the original noise audio data.

For an explanation of operation 206 in this embodiment of the present disclosure, refer to the foregoing explanation of operation 101. For an explanation of operation 207 in this embodiment of the present disclosure, refer to the foregoing explanation of operation 102.

Operation 208: Perform noise reduction processing on the original noise audio data based on the target noise reduction strength parameter by using the target noise reduction processing model, to obtain target enhanced audio data.

In some embodiments, the target noise reduction processing model may include a feature extraction network, a voice parsing network, and a voice generation network. Operation 208 may include: The computer device may extract a frequency domain signal of the original noise audio data by using the feature extraction network of the target noise reduction processing model. The frequency domain signal of the original noise audio data reflects a frequency domain feature of the original noise audio data. For example, the frequency domain signal of the original noise audio data reflects a change feature between a frequency and signal intensity of the original noise audio data. Then, the computer device may parse the frequency domain signal of the original noise audio data by using the voice parsing network of the target noise reduction processing model, to obtain a cosine transform mask of the original noise audio data. The cosine transform mask is configured for reflecting a proportion of audio data in the original noise audio data. In other words, the cosine transform mask is configured for reflecting the proportion of the audio data in the original noise audio data in the original noise audio data. Then, the target enhanced audio data may be generated by using the voice generation network of the target noise reduction processing model based on the cosine transform mask of the original noise audio data, the frequency domain signal of the original noise audio data, and the target noise reduction strength parameter. For example, the computer device may perform an exponential operation on the target noise reduction strength parameter, to obtain a noise reduction factor, for example,

$$1 {0}^{- \frac{{δ}_{s n r 2}}{20}} ;$$

obtain a difference between 1 and the cosine transform mask, obtain a product of the difference and the noise reduction factor, and obtain a sum of the product and the cosine transform mask, to obtain a noise reduction value; determine a product of the noise reduction value and the frequency domain signal of the original noise audio data as frequency domain enhanced audio data; and perform time domain transformation on the frequency domain audio data, to obtain the target enhanced audio data. Noise reduction processing is performed on the original noise audio data by using the target noise reduction processing model, so that a problem of a loss of the audio data in the original noise audio data can be avoided, a problem that noise residue is unstable in the target enhanced audio data can be avoided, stability and smoothness of the noise residue in the target enhanced audio data can be improved, and perceptibility of audio data in the target enhanced audio data can be improved.

In some embodiments, the parsing the frequency domain signal of the original noise audio data by using the voice parsing network of the target noise reduction processing model, to obtain a cosine transform mask of the original noise audio data includes: The computer device may perform voice feature extraction on the frequency domain signal of the original noise audio data through an encoding layer in the voice parsing network based on a first voice feature extraction mode, to obtain a first key voice feature; perform voice feature extraction on the first key voice feature based on a second voice feature extraction mode, to obtain a second key voice feature; perform voice feature extraction on the first key voice feature and the second key voice feature based on a third voice feature extraction mode, to obtain a third key voice feature; and parse the first key voice feature, the second key voice feature, and the third key voice feature, to obtain the cosine transform mask of the original noise audio data. Voice data (that is, the audio data) in the original noise audio data is extracted based on different voice feature extraction modes, to avoid a problem of a loss of the voice data caused by loss of a voice feature in the original noise audio data.

Because a vocal cord of the user vibrates to generate a pitch that is generally less than 500 Hz and a harmonic signal of the pitch, the computer device may extract a key voice feature based on a frequency distribution feature of the original noise audio data. Generally, a peak of a spectrum of the voice data usually occurs in a pitch frequency (the pitch) and the harmonic signal, and a spectrum of noise data is flat. Therefore, the computer device may extract the key voice feature based on flatness of a spectrum of the original noise audio data. In addition, the spectrum of the noise data is more stable than the spectrum of the voice data. To be specific, an overall waveform shape of the spectrum of the noise data tends to remain the same at any given stage. Therefore, the noise data and the voice data may be distinguished through a spectrum template difference of the original noise audio data, that is, the computer device may extract the key voice feature based on the spectrum template difference of the original noise audio data. In this embodiment of the present disclosure, the first voice feature extraction mode, the second voice feature extraction mode, and a third voice extraction mode are manners of extracting key voice features from different perspectives respectively. For example, the first voice feature extraction mode, the second voice feature extraction mode, and the third voice extraction mode each are one of the frequency distribution feature-based extraction mode, the flatness of the spectrum-based extraction mode, and the spectrum template difference-based extraction mode. The first voice feature extraction mode, the second voice feature extraction mode, and the third voice extraction mode may be different, or at least two extraction modes may be the same.

In some embodiments, the parsing the first key voice feature, the second key voice feature, and the third key voice feature, to obtain the cosine transform mask of the original noise audio data includes: The computer device may parse the third key voice feature through a timing parsing layer in the voice parsing network, to obtain timing information of the original noise audio data. The timing information of the original noise audio data reflects a relationship between the key voice feature in the original noise audio data and time. In some embodiments, the computer device may perform parsing through a decoding layer in the voice parsing network based on the timing information, the first key voice feature, the second key voice feature, and the third key voice feature, to obtain the cosine transform mask of the original noise audio data.

In some embodiments, the generating the target enhanced audio data by using the voice generation network of the target noise reduction processing model based on the cosine transform mask of the original noise audio data, the frequency domain signal of the original noise audio data, and the target noise reduction strength parameter includes: The computer device may determine an original signal-to-noise ratio of the original noise audio data by using the voice generation network of the target noise reduction processing model based on the frequency domain signal of the original noise audio data, and generate an enhanced signal-to-noise ratio of noise-reduced original noise audio data based on the original signal-to-noise ratio and the target noise reduction strength parameter. For example, it is assumed that the target noise reduction strength parameter is δₛₙᵣ₂, and a unit of the target noise reduction strength parameter δₛₙᵣ₂ is dB. The physical meaning is a signal-to-noise ratio of the original noise audio data that needs to be improved. The original signal-to-noise ratio of the original noise audio data is A. In this case, the enhanced signal-to-noise ratio of the noise-reduced original noise audio data may be λ+δₛₙᵣ₂. Then, the computer device may generate the target enhanced audio data based on the enhanced signal-to-noise ratio, the cosine transform mask of the original noise audio data, and the frequency domain signal of the original noise audio data. The noise data in the original noise audio data is quantitatively suppressed to avoid the loss of the audio data in the original noise audio data, improve stability and smoothness of the noise residue in the target enhanced audio data, and improve perceptibility of the audio data in the target enhanced audio data.

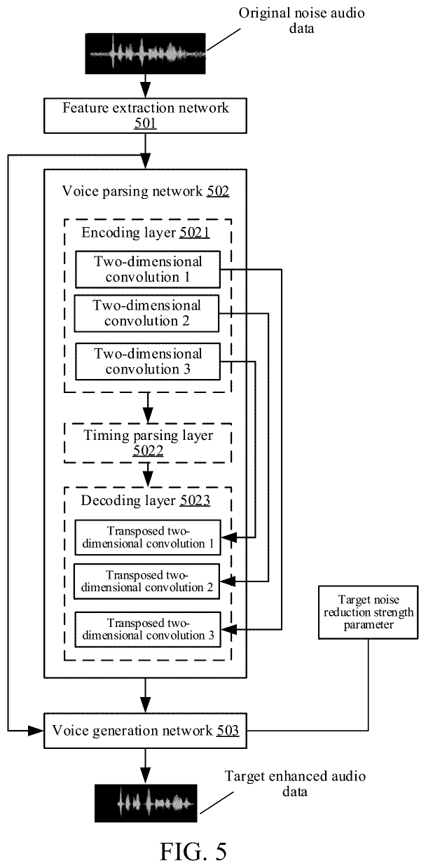

For example, as shown in FIG. 5, the target noise reduction processing model includes a feature extraction network 501, a voice parsing network 502, and a voice generation network 503. The feature extraction network is configured to perform frequency domain transformation on original noise audio data in time domain, to obtain a frequency domain signal of the original noise audio data. In some embodiments, the feature extraction network first performs a re-sampling operation on the original noise audio data xₙ, and resamples the original noise audio data of each sampling rate type to 48 KHz. After the re-sampling is completed, framing and windowing are performed on re-sampled original noise audio data. For example, the re-sampled original noise audio data may be divided into a plurality of noise audio data segments based on a frame length 1024 and a frame shift 512, and the plurality of noise audio data segments are separately modulated by using a Hamming window. After the framing and windowing are completed, a discrete cosine transform (DCT) operation is performed on a plurality of modulated noise audio data segments, to obtain the frequency domain signal Xₖ of the original noise audio data. A combination of the framing and windowing and the cosine transform operation on the original noise audio data may also be referred to as short-time discrete cosine transform (SDCT). The voice parsing network 502 is configured to extract a cosine transform mask of the original noise audio data. The voice parsing network may be a deep learning network module. The deep learning network module includes an encoding layer 5021, a timing parsing layer 5022, and a decoding layer 5023. The encoding layer 5021 may be formed by a plurality of two-dimensional convolutions. A convolution kernel size of each two-dimensional convolution is (5, 2). This represents that a frequency domain field of view is 5 and a time domain field of view is 2. For analysis processing on each frame of signal feature (that is, a frequency domain signal corresponding to a current noise audio data segment), refer to a previous frame of signal (that is, a frequency domain signal corresponding to a previous noise audio data segment). A stride of the two-dimensional convolution is (2, 1). This can reduce a quantity of frequency domain signals by half layer by layer, and remain quantity of time domain frames unchanged, so that the dimension is reduced and a calculation amount is reduced. As shown in FIG. 5, an example in which the encoding layer 5021 includes three two-dimensional convolutions is used, that is, a two-dimensional convolution 1, a two-dimensional convolution 2, and a two-dimensional convolution 3 respectively. The two-dimensional convolution 1, the two-dimensional convolution 2, and the two-dimensional convolution 3 respectively extract a first key voice feature, a second key voice feature, and a third key voice feature of the original noise audio data. The decoding layer 5023 partially mainly includes DecTConv2d with a transposed two-dimensional convolution (ConvTransposse2d) as a kernel. In FIG. 5, an example in which the decoding layer includes three transposed two-dimensional convolutions is used, that is, a transposed two-dimensional convolution 1, a transposed two-dimensional convolution 2, and a transposed two-dimensional convolution 3 respectively. A DecTConv2d parameter of each layer is the same as a corresponding two-dimensional convolution, so that a signal dimension is restored. The timing parsing layer 5022 is used between the encoding layer and the decoding layer. The timing parsing layer 5022 may be a recurrent neural network RNN module formed by stacking gated recurrent units (GRUs). The RNN mainly extracts and analyzes inter-frame timing information of an audio signal. Therefore, a workflow of the deep learning network module is that the encoding layer accepts the frequency domain signal of the original noise audio data from the feature extraction network, and then extracts high-dimensional features (that is, the first key voice feature, the second key voice feature, and the third key voice feature) layer by layer through the two-dimensional convolutions. A corresponding output is sent to the transposed two-dimensional convolution in a skip connection manner. The RNN accepts the third key voice feature outputted from the last layer of the two-dimensional convolution 3, performs timing information extraction and analysis, and sends an input to the decoding layer. The decoding layer receives the output from the RNN and the encoding layer, and performs layer-by-layer dimension upgrading processing, to finally obtain the cosine transform mask mk.

In some embodiments, the generating the target enhanced audio data based on the enhanced signal-to-noise ratio and the frequency domain signal includes:The computer device may perform noise reduction processing on the frequency domain signal of the original noise audio data based on the enhanced signal-to-noise ratio and the cosine transform mask of the original noise audio data, to obtain frequency domain enhanced audio data; transform the frequency domain enhanced audio data, to obtain time domain enhanced audio data; and determine the time domain enhanced audio data as the target enhanced audio data.

For example, it is assumed that the frequency domain signal of the original noise audio data is Xₖ, a frequency domain signal of the audio data in the original noise audio data is Yₖ, and a frequency domain signal of the noise data in the original noise audio data is Dₖ. The frequency domain signal of the original noise audio data may be represented by using the following Formula (3):

$${X}_{k} = {Y}_{k} + {D}_{k} \qquad ( 3 )$$

k in Formula (3) is a k^{th} sampling point of the original noise audio data, and k is a positive integer greater than 1. Based on Formula (3), the original signal-to-noise ratio of the original noise audio data may be represented by using the following Formula (4):

$$λ = 10 {log}_{10} ( \frac{{Y}_{k}^{2}}{{D}_{k}^{2}} ) \qquad ( 4 )$$

It is assumed that the frequency domain enhanced audio data is \hat{X}ₖ, a frequency domain signal of audio data in the frequency domain enhanced audio data is Ŷₖ, and a frequency domain signal of noise data in the frequency domain enhanced audio data is \hat{D}ₖ. The frequency domain signal of the frequency domain enhanced audio data may be represented by using the following Formula (5):

$${\hat{X}}_{k} = {\hat{Y}}_{k} + {\hat{D}}_{k} \qquad ( 5 )$$

In some embodiments, based on Formula (5), the enhanced signal-to-noise ratio of the noise-reduced original noise audio data may be represented by using the following Formula (6):

$$λ + {δ}_{s n r 2} = 10 {log}_{10} ( \frac{{\hat{Y}}_{k}^{2}}{{\hat{D}}_{k}^{2}} ) \qquad ( 6 )$$

Because the cosine transform mask of the original noise audio data reflects the proportion of the audio data in the original noise audio data, a relationship between the frequency domain signal Xₖ of the original noise audio data and the frequency domain signal Ŷₖ of the audio data in the frequency domain enhanced audio data may be represented by using the following Formula (7):

$${\hat{Y}}_{k} = {X}_{k} \cdot {\hat{m}}_{k} \qquad ( 7 )$$

In Formula (7), \hat{m}ₓ is the cosine transform mask of the original noise audio data. Based on Formula (4), Formula (6), and Formula (7), the frequency domain signal \hat{D}ₖ of the noise data in the frequency domain enhanced audio data may be represented by using the following Formula (8):

$${\hat{D}}_{k} = {X}_{k} \cdot ( 1 - {\hat{m}}_{k} ) \cdot {10}^{- \frac{{δ}_{s n r 2}}{20}} \qquad ( 8 )$$

In some embodiments, based on Formula (7) and Formula (8), Formula (5) may be transformed into the following Formula (9):

$${\hat{X}}_{k} = {X}_{k} \cdot [ {\hat{m}}_{k} + ( 1 - {\hat{m}}_{k} ) \cdot {10}^{- \frac{{δ}_{s n r 2}}{20}} ] \qquad ( 9 )$$

Then, the computer device performs time domain transformation on Formula (9), to obtain the target enhanced audio data.

In some embodiments, in this embodiment of the present disclosure, the target noise reduction strength parameter is introduced to quantitatively control a noise processing strength of an algorithm on the original noise audio data. The target noise reduction strength parameter can be flexibly configured for different application scenarios and/or collection scenarios of the original noise audio data, to improve adaptability of the present disclosure to different scenarios, and improve generalization of the present disclosure. The present disclosure can cover most voice data application scenarios and actual requirements, and reduce difficulty of algorithm development and system complexity. Because a new model training mode is used in the present disclosure to satisfy a requirement on a controllable noise reduction strength, instead of using a pure voice as a target enhanced voice, a voice signal (that is, sample audio data) and a noise signal (that is, sample noise data) are mixed based on a specific signal-to-noise ratio (a sample noise reduction strength parameter), to obtain a target enhanced voice (that is, annotated voice enhanced data). This can, to a certain extent, avoid a voice loss problem and a noise residue discontinuity problem that are common in a voice enhancement and noise reduction algorithm.

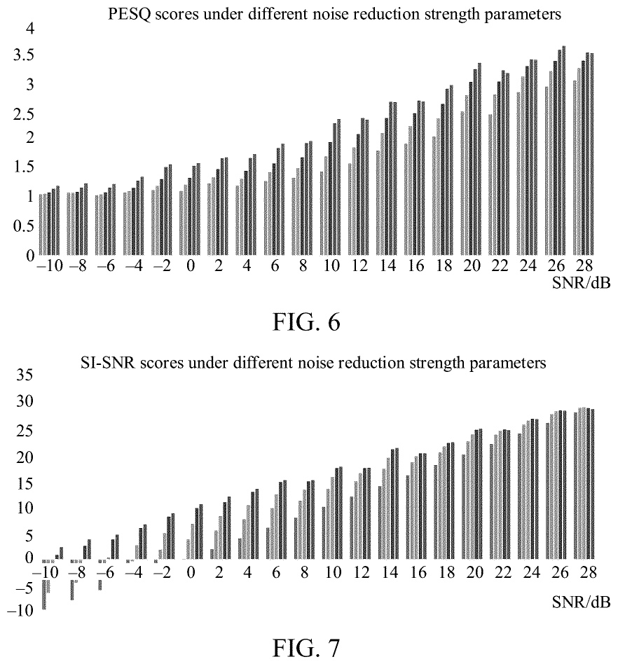

Then, noise reduction effect performance of the present disclosure under different noise reduction strength parameters is provided. A batch of test data (that is, noise audio data) is generated based on a signal-to-noise ratio range of [−10, 30] dB, and the noise reduction strength parameter δₛₙᵣ is set to 5 dB, 10 dB, 20 dB, and 40 dB respectively. Two commonly used voice enhancement noise reduction quality evaluation indexes, that are, a perceptual evaluation of speech quality (PESQ) parameter and a scale-invariant source-to-noise ratio (SI-SNR) parameter, are selected as reference indexes for the noise reduction effect. FIG. 6 shows perceptual evaluation of speech quality (PESQ) scores of noise audio data under different noise reduction strength parameters. In FIG. 6, a horizontal coordinate shows an original signal-to-noise ratio of noise audio data, and a vertical coordinate shows PESQ scores of the noise audio data after noise reduction processing is performed based on a noise reduction strength parameter. Each original signal-to-noise ratio corresponds to five rectangles. Under a same original signal-to-noise ratio, a length of a first rectangle from left to right shows PESQ scores without noise reduction processing of the noise audio data, and lengths of a second rectangle to a fifth rectangle respectively show PESQ scores of the noise audio data after noise reduction processing is performed based on the noise reduction strength parameters of 5 dB, 10 dB, 20 dB, and 40 dB. It can be learned from FIG. 6 that, the PESQ scores of the noise audio data processed based on the noise reduction strength parameter is higher than the PESQ scores of the noise audio data without noise reduction processing. This is particularly apparent when the original signal-to-noise ratio of the noise audio data is greater than 4 dB. In addition, under the same original signal-to-noise ratio, a larger noise reduction strength parameter indicates higher PESQ scores of the noise audio data processed based on the noise reduction strength parameter. A smaller noise reduction strength parameter indicates lower PESQ scores of the noise audio data after processing based on the noise reduction strength parameter.

FIG. 7 shows scale-invariant signal-to-noise ratio (SI-SNR) scores of noise audio data under different noise reduction strength parameters. In FIG. 7, a horizontal coordinate shows an original signal-to-noise ratio of noise audio data, and a vertical coordinate shows SI-SNR scores of the noise audio data after noise reduction processing is performed based on a noise reduction strength parameter. Each original signal-to-noise ratio corresponds to five rectangles. Under a same original signal-to-noise ratio, a length of a first rectangle from left to right shows SI-SNR scores without denoising processing of the noise audio data, and lengths of a second rectangle to a fifth rectangle respectively show SI-SNR scores of the noise audio data after noise reduction processing is performed based on the noise reduction strength parameters of 5 dB, 10 dB, 20 dB, and 40 dB. It can be learned from FIG. 7 that, the SI-SNR scores of the noise audio data processed based on the noise reduction strength parameter is higher than the SI-SNR scores of the noise audio data without noise reduction processing. This is particularly apparent when the original signal-to-noise ratio of the noise audio data is greater than 4 dB. In addition, under the same original signal-to-noise ratio, a larger noise reduction strength parameter indicates higher SI-SNR scores of the noise audio data processed based on the noise reduction strength parameter. A smaller noise reduction strength parameter indicates lower SI-SNR scores of the noise audio data after processing based on the noise reduction strength parameter.

In the embodiments of the present disclosure, a target noise reduction strength parameter configured for performing noise reduction processing on the original noise audio data is adaptively determined based on a target scenario parameter associated with the original noise audio data, and noise content in the original noise audio data is quantitatively reduced based on the target noise reduction strength parameter. To be specific, the target scenario parameter reflects at least one of an application scenario and a collection scenario of the original noise audio data, and the target noise reduction strength parameter reflects a strength of suppressing noise in the original noise audio data. In other words, an actual requirement for the audio data in the application scenario of the original noise audio data (and/or noise distribution in the collection scenario of the original noise audio data) is used to quantitatively reduce the noise content in the original noise audio data, and accept a certain level of noise residuals. There is no need to completely separate the noise data and the audio data in the original noise audio data, to completely suppress the noise, avoid loss of effective audio data during noise reduction, improve quality of the audio data, and improve flexibility of noise processing.

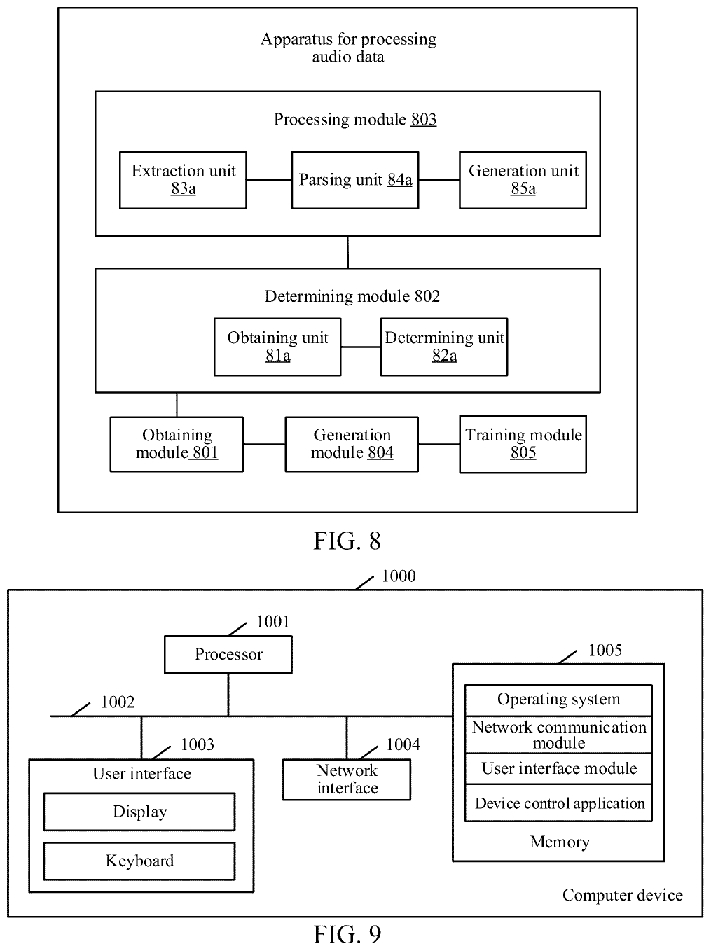

FIG. 8 is a schematic diagram of a structure of an apparatus for processing audio data according to an embodiment of the present disclosure. The apparatus for processing audio data may be a computer program (including program code) running in a network device. For example, the apparatus for processing audio data is application software. The apparatus may be configured to perform corresponding operations in the method provided in the embodiments of the present disclosure. As shown in FIG. 8, the apparatus for processing audio data may include:

an obtaining module 801, configured to obtain original noise audio data to be processed, and a target scenario parameter associated with the original noise audio data; a determining module 802, configured to determine, based on the target scenario parameter, a target noise reduction strength parameter configured for performing noise reduction processing on the original noise audio data; and a processing module 803, configured to perform noise reduction processing on the original noise audio data based on the target noise reduction strength parameter, to obtain target enhanced audio data.

In some embodiments, the determining module 802 includes an obtaining unit 81a and a determining unit 82a. The obtaining unit 81a is configured to obtain a quality requirement level of audio data in an application scenario if the target scenario parameter is configured for determining the application scenario of the original noise audio data. The determination unit 82a is configured to determine, based on the quality requirement level, the target noise reduction strength parameter configured for performing noise reduction processing on the original noise audio data.

The obtaining unit 81a is configured to historical noise data in a historical time period in a collection scenario if the target scenario parameter is configured for determining the collection scenario of the original noise audio data. The determination unit 82a is configured to determine, based on the historical noise data, the target noise reduction strength parameter configured for performing noise reduction processing on the original noise audio data.

In some embodiments, that the determination unit 82a determines, based on the historical noise data, the target noise reduction strength parameter configured for performing noise reduction processing on the original noise audio data includes: determining, from the historical noise data, a noise type and a noise change feature that correspond to noise data in the collection scenario in the historical time period; and determining, based on the noise type and the noise change feature, the target noise reduction strength parameter configured for performing noise reduction processing on the original noise audio data.

In some embodiments, the noise data in the collection scenario in the historical time period corresponds to M noise types, and the determining unit 82a determines, based on the noise type and the noise change feature, the target noise reduction strength parameter configured for performing noise reduction processing on the original noise audio data includes: determining, based on noise change features corresponding to the M noise types respectively, M candidate noise reduction strength parameters configured for performing noise reduction processing on the original noise audio data; and determining the M candidate noise reduction strength parameters as target noise reduction strength parameters; or performing mean value calculation on the M candidate noise intensity parameters, to obtain the target noise reduction strength parameter.

The processing module 803 includes an extraction unit 83a, a parsing unit 84a, and a generation unit 85a. The extraction unit 83a is configured to extract a frequency domain signal of the original noise audio data through a feature extraction network of a target noise reduction processing model; The parsing unit 84a is configured to parse the frequency domain signal of the original noise audio data through a voice parsing network of the target noise reduction processing model, to obtain a cosine transform mask of the original noise audio data, the cosine transform mask reflecting a proportion of audio data in the original noise audio data. The generation unit 85a id configured to generate the target enhanced audio data through a voice generation network of the target noise reduction processing model based on the cosine transform mask of the original noise audio data, the frequency domain signal of the original noise audio data, and the target noise reduction strength parameter.

In some embodiments, that the parsing unit 84a parses the frequency domain signal of the original noise audio data through a voice parsing network of the target noise reduction processing model, to obtain a cosine transform mask of the original noise audio data includes: performing voice feature extraction on the frequency domain signal of the original noise audio data through an encoding layer in the voice parsing network based on a first voice feature extraction mode, to obtain a first key voice feature; performing voice feature extraction on the first key voice feature based on a second voice feature extraction mode, to obtain a second key voice feature; performing voice feature extraction on the first key voice feature and the second key voice feature based on a third voice feature extraction mode, to obtain a third key voice feature; and parsing the first key voice feature, the second key voice feature, and the third key voice feature, to obtain the cosine transform mask of the original noise audio data.

In some embodiments, that the parsing unit 84a parses the first key voice feature, the second key voice feature, and the third key voice feature, to obtain the cosine transform mask of the original noise audio data includes: parsing the third key voice feature through a timing parsing layer in the voice parsing network, to obtain timing information of the original noise audio data; and performing parsing through a decoding layer in the voice parsing network based on the timing information, the first key voice feature, the second key voice feature, and the third key voice feature, to obtain the cosine transform mask of the original noise audio data.

In some embodiments, that the generation unit 85a generates the target enhanced audio data by using the voice generation network of the target noise reduction processing model based on the cosine transform mask of the original noise audio data, the frequency domain signal of the original noise audio data, and the target noise reduction strength parameter includes: determining an original signal-to-noise ratio of the original noise audio data by using the voice generation network of the target noise reduction processing model based on the frequency domain signal of the original noise audio data; generating, based on the original signal-to-noise ratio and the target noise reduction strength parameter, an enhanced signal-to-noise ratio of noise-reduced original noise audio data; and generating the target enhanced audio data based on the enhanced signal-to-noise ratio, the cosine transform mask of the original noise audio data, and the frequency domain signal of the original noise audio data.

In some embodiments, that the generation unit 85a generates the target enhanced audio data based on the enhanced signal-to-noise ratio, the cosine transform mask of the original noise audio data, and the frequency domain signal of the original noise audio data includes: performing noise reduction processing on the frequency domain signal of the original noise audio data based on the enhanced signal-to-noise ratio, the cosine transform mask of the original noise audio data, to obtain frequency domain enhanced audio data; and transforming the frequency domain enhanced audio data, to obtain time domain enhanced audio data, and determining the time domain enhanced audio data as the target enhanced audio data.

The obtaining module 801 is further configured to: obtain sample audio data and sample noise data, and generate sample noise audio data based on the sample audio data and the sample noise data; and obtain a sample noise reduction strength parameter configured for performing noise reduction processing on the sample noise audio data. The generation module 804 is configured to generate annotated voice enhanced data based on the sample noise reduction strength parameter, the sample audio data, and the sample noise data. The processing module 803 is configured to perform noise reduction processing on the sample noise audio data based on the sample noise reduction strength parameter by using an initial noise reduction processing model, to obtain predicted voice enhanced data. The training module 805 is configured to perform optimization training on the initial noise reduction processing model based on the predicted voice enhanced data and the annotated voice enhanced data, to obtain the target noise reduction processing model.

In some embodiments, that the training module 805 performs the optimization training on the initial noise reduction processing model based on the predicted voice enhanced data and the annotated voice enhanced data, to obtain the target noise reduction processing model includes: determining a noise reduction processing error of the initial noise reduction processing model based on the predicted voice enhanced data and the annotated voice enhanced data; determining stability of noise data included in the predicted voice enhanced data based on the predicted voice enhanced data; and adjusting a model parameter of the initial noise reduction processing model based on the noise reduction processing error and the stability, to obtain the target noise reduction processing model.

In some embodiments, that the training module 805 adjusts a model parameter of the initial noise reduction processing model based on the noise reduction processing error and the stability, to obtain the target noise reduction processing model includes: determining a convergence status of the initial noise reduction processing model based on the noise reduction processing error; adjusting the model parameter of the initial noise reduction processing model based on the noise reduction processing error if the convergence status of the initial noise reduction processing model is an unconverged state, or the stability is less than a stability threshold; and determining an adjusted initial noise reduction processing model as the target noise reduction processing model until a convergence status of the adjusted initial noise reduction processing model is a converged state and corresponding stability is greater than or equal to the stability threshold.

In some embodiments, that the generation module 804 generates annotated voice enhanced data based on the sample noise reduction strength parameter, the sample audio data, and the sample noise data includes: performing noise reduction processing on the sample noise data based on the sample noise reduction strength parameter, to obtain processed sample noise data; and combining the processed sample noise data and the sample audio data, to obtain annotated voice enhanced data.

According to an embodiment of the present disclosure, the operations involved in the foregoing method for processing audio data may be performed by various modules in the apparatus for processing audio data shown in FIG. 8. For example, operation 101 shown in FIG. 3 may be performed by the obtaining module 801 in FIG. 8, operation 102 shown in FIG. 3 may be performed by the determining module 802 in FIG. 8, and operation 103 shown in FIG. 3 may be performed by the processing module 803 in FIG. 8.

According to an embodiment of the present disclosure, the modules in the apparatus for processing audio data shown in FIG. 8 may be separately or all combined into one or several units, or one (or more) of units may be further split into at least two sub-units having smaller functions, so that the same operations can be implemented without affecting the implementation of the technical effects of the embodiments of the present disclosure. The foregoing modules are divided based on logical functions. In actual application, a function of one module may also be implemented by at least two units, or functions of at least two modules are implemented by one unit. In other embodiments of the present disclosure, the apparatus for processing audio data may also include another unit. In an actual implementation, these functions may also be implemented with assistance by another unit, and may be implemented with cooperation by at least two units.

According to an embodiment of the present disclosure, the apparatus for processing audio data shown in FIG. 8 may be constructed and the method for processing audio data in the embodiments of the present disclosure may be implemented by running a computer program (including program code) that can perform the operations involved in the corresponding methods shown in the foregoing descriptions on a general-purpose computer device such as a computer that includes processing components and storage components such as a central processing unit (CPU), a random access storage medium (RAM), and a read-only storage medium (ROM). The foregoing computer program may be recorded in, for example, a computer-readable recording medium, and may be loaded into the foregoing computer device by using the computer-readable recording medium and run in the computer device.

In some embodiments, the target noise reduction strength parameter configured for performing noise reduction processing on the original noise audio data is adaptively determined based on the target scenario parameter associated with the original noise audio data, and the noise content in the original noise audio data is quantitatively reduced based on the target noise reduction strength parameter. To be specific, the target scenario parameter reflects at least one of the application scenario and the collection scenario of the original noise audio data, and the target noise reduction strength parameter reflects a strength of suppressing noise in the original noise audio data. In other words, an actual requirement for the audio data in the application scenario of the original noise audio data (and/or noise distribution in the collection scenario of the original noise audio data) is used to quantitatively reduce the noise content in the original noise audio data, and accept a certain level of noise residuals. There is no need to completely separate the noise data and the audio data in the original noise audio data, to completely suppress the noise, avoid loss of effective audio data during noise reduction, improve quality of the audio data, and improve flexibility of noise processing.

In the embodiments of the present disclosure, when the embodiments of the present disclosure are applied to a specific product or technology, data related to the original noise audio data, the target enhanced audio data, and the like, such as collection, use, and processing of the related data need to comply with the laws, regulations, and standards of related countries and regions.

FIG. 9 is a schematic diagram of a structure of a computer device according to an embodiment of the present disclosure. As shown in FIG. 9, the foregoing computer device 1000 may be the first device in the foregoing method, and may be a terminal or a server, including a processor 1001, a network interface 1004, and a memory 1005. In addition, the foregoing computer device 1000 may further include a user interface 1003, and at least one communication bus 1002. The communication bus 1002 is configured to implement connection and communication between the components. In some embodiments, the user interface 1003 may include a display and a keyboard. In some embodiments, the user interface 1003 may further include a standard wired interface and a standard wireless interface. In some embodiments, the network interface 1004 may include the standard wired interface and the standard wireless interface (such as a WI-FI interface). The memory 1005 may be a high-speed RAM memory, or may be a non-volatile memory, for example, at least one magnetic disk memory. In some embodiments, the memory 1005 may further be at least one storage apparatus away from the foregoing processor 1001. As shown in FIG. 9, the memory 1005 used as a computer-readable storage medium may include an operating system, a network communication module, a user interface module, and a computer application.

In the computer device 1000 shown in FIG. 9, the network interface 1004 may provide a network communication function. The user interface 1003 is mainly configured to provide an input interface. The processor 1001 may be configured to invoke the computer application stored in the memory 1005 to obtain original noise audio data to be processed, and a target scenario parameter associated with the original noise audio data; determine, based on the target scenario parameter, a target noise reduction strength parameter configured for performing noise reduction processing on the original noise audio data; and perform noise reduction processing on the original noise audio data based on the target noise reduction strength parameter, to obtain target enhanced audio data.

In some embodiments, that the processor 1001 may be configured to invoke the computer application stored in the memory 1005 to determine, based on the target scenario parameter, a target noise reduction strength parameter configured for performing noise reduction processing on the original noise audio data includes: obtaining a quality requirement level of audio data in an application scenario if the target scenario parameter reflects the application scenario of the original noise audio data; and determining, based on the quality requirement level, the target noise reduction strength parameter configured for performing noise reduction processing on the original noise audio data.

In some embodiments, that the processor 1001 may be configured to invoke the computer application stored in the memory 1005 to determine, based on the target scenario parameter, a target noise reduction strength parameter configured for performing noise reduction processing on the original noise audio data includes: obtaining historical noise data in a historical time period in a collection scenario if the target scenario parameter reflects the collection scenario of the original noise audio data; and determining, based on the historical noise data, the target noise reduction strength parameter configured for performing noise reduction processing on the original noise audio data.

In some embodiments, the processor 1001 may be configured to invoke the computer application stored in the memory 1005 to determine, based on the historical noise data, a target noise reduction strength parameter configured for performing noise reduction processing on the original noise audio data includes: determining, from the historical noise data, a noise type and a noise change feature that correspond to noise data in the collection scenario in the historical time period; and determining, based on the noise type and the noise change feature, the target noise reduction strength parameter configured for performing noise reduction processing on the original noise audio data.

In some embodiments, that the processor 1001 may be configured to invoke the computer application stored in the memory 1005 to perform noise reduction processing on the original noise audio data based on the target noise reduction strength parameter, to obtain target enhanced audio data includes: extracting a frequency domain signal of the original noise audio data by using the feature extraction network of the target noise reduction processing model; parsing the frequency domain signal of the original noise audio data by using the voice parsing network of the target noise reduction processing model, to obtain a cosine transform mask of the original noise audio data, the cosine transform mask reflecting a proportion of audio data in the original noise audio data; and generating the target enhanced audio data by using the voice generation network of the target noise reduction processing model based on the cosine transform mask of the original noise audio data, the frequency domain signal of the original noise audio data, and the target noise reduction strength parameter.

In some embodiments, that the processor 1001 may be configured to invoke the computer application stored in the memory 1005 to parse the frequency domain signal of the original noise audio data through a voice parsing network of the target noise reduction processing model, to obtain a cosine transform mask of the original noise audio data includes: performing voice feature extraction on the frequency domain signal of the original noise audio data through an encoding layer in the voice parsing network based on a first voice feature extraction mode, to obtain a first key voice feature; performing voice feature extraction on the first key voice feature based on a second voice feature extraction mode, to obtain a second key voice feature; performing voice feature extraction on the first key voice feature and the second key voice feature based on a third voice feature extraction mode, to obtain a third key voice feature; and parsing the first key voice feature, the second key voice feature, and the third key voice feature, to obtain the cosine transform mask of the original noise audio data.

In some embodiments, that the processor 1001 may be configured to invoke the computer application stored in the memory 1005 to parse the first key voice feature, the second key voice feature, and the third key voice feature, to obtain the cosine transform mask of the original noise audio data includes: parsing the third key voice feature through a timing parsing layer in the voice parsing network, to obtain timing information of the original noise audio data; and performing parsing through a decoding layer in the voice parsing network based on the timing information, the first key voice feature, the second key voice feature, and the third key voice feature, to obtain the cosine transform mask of the original noise audio data.

In some embodiments, that the processor 1001 may be configured to invoke the computer application stored in the memory 1005 to generate the target enhanced audio data by using the voice generation network of the target noise reduction processing model based on the cosine transform mask of the original noise audio data, the frequency domain signal of the original noise audio data, and the target noise reduction strength parameter includes: determining an original signal-to-noise ratio of the original noise audio data by using the voice generation network of the target noise reduction processing model based on the frequency domain signal of the original noise audio data; generating, based on the original signal-to-noise ratio and the target noise reduction strength parameter, an enhanced signal-to-noise ratio of noise-reduced original noise audio data; and generating the target enhanced audio data based on the enhanced signal-to-noise ratio, the cosine transform mask of the original noise audio data, and the frequency domain signal of the original noise audio data.

In some embodiments, that the processor 1001 may be configured to invoke the computer application stored in the memory 1005 to generate the target enhanced audio data based on the enhanced signal-to-noise ratio, the cosine transform mask of the original noise audio data, and the frequency domain signal of the original noise audio data includes: performing noise reduction processing on the frequency domain signal of the original noise audio data based on the enhanced signal-to-noise ratio, the cosine transform mask of the original noise audio data, to obtain frequency domain enhanced audio data; transforming the frequency domain enhanced audio data, to obtain time domain enhanced audio data; and determining the time domain enhanced audio data as the target enhanced audio data.

In some embodiments, the processor 1001 may be configured to invoke the computer application stored in the memory 1005 to obtain sample audio data and sample noise data, generate sample noise audio data based on the sample audio data and the sample noise data; obtain a sample noise reduction strength parameter configured for performing noise reduction processing on the sample noise audio data; generate annotated voice enhanced data based on the sample noise reduction strength parameter, the sample audio data, and the sample noise data; perform noise reduction processing on the sample noise audio data based on the sample noise reduction strength parameter by using an initial noise reduction processing model, to obtain predicted voice enhanced data; and perform optimization training on the initial noise reduction processing model based on the predicted voice enhanced data and the annotated voice enhanced data, to obtain the target noise reduction processing model.

In some embodiments, that the processor 1001 may be configured to invoke the computer application stored in the memory 1005 to perform optimization training on the initial noise reduction processing model based on the predicted voice enhanced data and the annotated voice enhanced data, to obtain the target noise reduction processing model includes: determining a noise reduction processing error of the initial noise reduction processing model based on the predicted voice enhanced data and the annotated voice enhanced data; determining stability of noise data included in the predicted voice enhanced data based on the predicted voice enhanced data; and adjusting a model parameter of the initial noise reduction processing model based on the noise reduction processing error and the stability, to obtain the target noise reduction processing model.

In some embodiments, that the processor 1001 may be configured to invoke the computer application stored in the memory 1005 to adjust a model parameter of the initial noise reduction processing model based on the noise reduction processing error and the stability, to obtain the target noise reduction processing model includes: determining a convergence status of the initial noise reduction processing model based on the noise reduction processing error; adjusting the model parameter of the initial noise reduction processing model based on the noise reduction processing error if the convergence status of the initial noise reduction processing model is an unconverged state, or the stability is less than a stability threshold; and determining an adjusted initial noise reduction processing model as the target noise reduction processing model until a convergence status of the adjusted initial noise reduction processing model is a converged state and corresponding stability is greater than or equal to the stability threshold.

In some embodiments, that the processor 1001 may be configured to invoke the computer application stored in the memory 1005 to generate annotated voice enhanced data based on the sample noise reduction strength parameter, the sample audio data, and the sample noise data includes: performing noise reduction processing on the sample noise data based on the sample noise reduction strength parameter, to obtain processed sample noise data; and combining the processed sample noise data and the sample audio data, to obtain annotated voice enhanced data.

In some embodiments, the target noise reduction strength parameter configured for performing noise reduction processing on the original noise audio data is adaptively determined based on the target scenario parameter associated with the original noise audio data, and the noise content in the original noise audio data is quantitatively reduced based on the target noise reduction strength parameter. To be specific, the target scenario parameter reflects at least one of the application scenario and the collection scenario of the original noise audio data, and the target noise reduction strength parameter reflects the strength of suppressing noise in the original noise audio data. In other words, an actual requirement for the audio data in the application scenario of the original noise audio data (and/or noise distribution in the collection scenario of the original noise audio data) is used to quantitatively reduce the noise content in the original noise audio data, and accept a certain level of noise residuals. There is no need to completely separate the noise data and the audio data in the original noise audio data, to completely suppress the noise, avoid loss of effective audio data during noise reduction, improve quality of the audio data, and improve flexibility of noise processing.

The computer device described in this embodiment of the present disclosure may perform the foregoing descriptions of the method for processing audio data in the foregoing corresponding embodiments, and may also perform the foregoing descriptions of the apparatus for processing audio data in the foregoing corresponding embodiments.

In addition, the embodiments of the present disclosure further provide a computer-readable storage medium. The computer-readable storage medium stores a computer program executed by the foregoing apparatus for processing audio data. The computer program includes program instructions. When executing the program instructions, a processor can perform the descriptions of the method for processing audio data in the foregoing corresponding embodiments. In addition, descriptions of beneficial effects of using the same method are not repeated. For technical details not disclosed in the embodiment of the computer-readable storage medium involved in the present disclosure, refer to the descriptions of the method embodiments of the present disclosure.

For example, the foregoing program instructions may be deployed on one computer device for execution, or deployed on at least two computer devices at one location for execution, or deployed on at least two computer devices that are distributed at least two locations and interconnected by a communication network for execution. The at least two computer devices that are distributed at the at least two locations and interconnected by the communication network may form a blockchain network.

The foregoing computer-readable storage medium may be an apparatus for processing audio data according to any one of the foregoing embodiments or an intermediate storage unit of the foregoing computer device, for example, a hard disk drive or an internal memory of the computer device. The computer-readable storage medium may alternatively be an external storage device of the computer device, for example, a plug-in hard disk drive, a smart media card (SMC), a secure digital (SD) card, or a flash card equipped on the computer device. In some embodiments, the computer-readable storage medium may further include both an intermediate storage unit and an external storage device of the computer device. The computer-readable storage medium is configured to store the computer program and other programs and data required by the computer device. The computer-readable storage medium may be further configured to temporarily store data that has been outputted or that is to be outputted.

In the specification, claims, and accompanying drawings of the present this embodiment, the terms such as “first” and “second” are intended to distinguish between different in the accommodation defined as than indicate a particular order. In the specification, claims, and accompanying drawings of the embodiments of the present disclosure such as the terms “first”, “second”, and the like are used to distinguish between different media contents, rather than indicate a specific order. In addition, the terms “include” and any variant thereof are intended to cover a non-exclusive inclusion. For example, a process, method, apparatus, product, or device that comprises a series of steps or units is not limited to the listed steps or modules; and instead, further exemplarily comprises an operation or module that is not listed, or further exemplarily comprises another operation or unit that is intrinsic to the process, method, apparatus, product, or device.

In some embodiments, in the foregoing embodiments of the present disclosure, if user information and the like need to be used, user permission or consent needs to be obtained, and relevant laws and regulations of relevant countries and regions need to be complied with.

An embodiment of the present disclosure further provides a computer program product, including a computer program/instructions. The computer program/instructions, when executed by a processor, implement the descriptions of the method for processing audio data and the decoding method in the foregoing corresponding embodiments. In addition, descriptions of beneficial effects of using the same method are not repeated. For technical details not disclosed in the embodiment of the computer program product involved in the present disclosure, refer to the descriptions of the method embodiments of the present disclosure.

A person of ordinary skill in the art may notice that the exemplary units and algorithm steps described with reference to the embodiments disclosed in this specification can be implemented in electronic hardware, or a combination of computer software and electronic hardware. To clearly describe the interchangeability of hardware and software, the foregoing descriptions have generally described compositions and operations of the examples according to functions. Whether the functions are executed in a mode of hardware or software depends on particular applications and design constraint conditions of the technical solutions. A person skilled in the art may use different methods to implement the described functions for each particular application, but such implementation is not to be considered outside of the scope of the present disclosure.

The method and the related apparatus provided in the embodiments of the present disclosure are described with reference to the method flowcharts and/or schematic structural diagrams provided in the embodiments of the present disclosure. Each process and/or block in the method flowcharts and/or schematic structural diagrams and a combination of processes and/or blocks in the flowcharts and/or block diagrams may be implemented by the computer program instructions. These computer program instructions may be provided to a general-purpose computer, a dedicated computer, an embedded processing machine, or a processor of another programmable network connection device to generate a machine, so that the instructions executed by the computer or the processor of the another programmable network connection device generate an apparatus for implementing the functions specified in one or more processes of the flowcharts and/or one or more blocks of the schematic diagrams of structures. These computer program instructions may also be stored in a computer readable memory that can instruct a computer or any other programmable network connection device to work in a specific manner, so that the instructions stored in the computer readable memory generate an artifact that includes an instruction apparatus. The instruction apparatus implements a specific function in one or more processes in the flowcharts and/or in one or more blocks in the schematic diagrams of structures. These computer program instructions may also be loaded onto a computer or another programmable network connection device, so that a series of operations and steps are performed on the computer or the another programmable device, to generate computer-implemented processing. Therefore, the instructions executed on the computer or the another programmable device provide steps for implementing a specific function in one or more processes in the flowcharts and/or in one or more blocks in the schematic diagrams of structures. What is disclosed above is merely exemplary embodiments of the present disclosure, and certainly is not intended to limit the scope of the claims of the present disclosure. Therefore, equivalent variations made in accordance with the claims of the present disclosure still fall within the scope of the present disclosure.

What is claimed is:

1. A method for processing audio data, applied to a computer device, comprising:
obtaining original noise audio data to be processed, and a target scenario parameter associated with the original noise audio data;
determining, based on the target scenario parameter, a target noise reduction strength parameter for noise reduction processing; and
performing the noise reduction processing on the original noise audio data based on the target noise reduction strength parameter, to obtain target enhanced audio data.

2. The method according to claim 1, wherein the target scenario parameter is for determining an application scenario of the original noise audio data, and the determining, based on the target scenario parameter, a target noise reduction strength parameter comprises:
obtaining, based on the target scenario parameter, a quality requirement level of audio data in the application scenario; and
determining, based on the quality requirement level, the target noise reduction strength parameter.

3. The method according to claim 1, wherein the target scenario parameter is for determining an collection scenario of the original noise audio data, and the determining, based on the target scenario parameter, a target noise reduction strength parameter comprises:
obtaining, based on the target scenario parameter, historical noise data in a historical time period in the collection scenario; and
determining, based on the historical noise data, the target noise reduction strength parameter.

4. The method according to claim 3, wherein the determining, based on the historical noise data, the target noise reduction strength parameter comprises:
determining, from the historical noise data, a noise type and a noise change feature that correspond to noise data in the collection scenario in the historical time period; and
determining, based on the noise type and the noise change feature, the target noise reduction strength parameter.

5. The method according to claim 4, wherein the noise data in the collection scenario in the historical time period corresponds to M noise types, and the determining, based on the noise type and the noise change feature, the target noise reduction strength parameter comprises:
determining, based on noise change features corresponding to the M noise types respectively, M candidate noise reduction strength parameters for the noise reduction processing; and
determining the M candidate noise reduction strength parameters as target noise reduction strength parameters; or
performing mean value calculation on the M candidate noise intensity parameters, to obtain the target noise reduction strength parameter.

6. The method according to claim 1, wherein the performing the noise reduction processing on the original noise audio data based on the target noise reduction strength parameter, to obtain target enhanced audio data comprises:
obtaining a target noise reduction processing model, the target noise reduction processing model comprising a feature extraction network, a voice parsing network, and a voice generation network;
extracting a frequency domain signal of the original noise audio data by using the feature extraction network;
parsing the frequency domain signal of the original noise audio data by using the voice parsing network, to obtain a cosine transform mask of the original noise audio data, the cosine transform mask reflecting a proportion of audio data in the original noise audio data; and
generating the target enhanced audio data by using the voice generation network based on the cosine transform mask of the original noise audio data, the frequency domain signal of the original noise audio data, and the target noise reduction strength parameter.

7. The method according to claim 6, wherein the parsing the frequency domain signal of the original noise audio data by using the voice parsing network, to obtain a cosine transform mask of the original noise audio data comprises:
performing voice feature extraction on the frequency domain signal of the original noise audio data through an encoding layer in the voice parsing network based on a first voice feature extraction mode, to obtain a first key voice feature;
performing voice feature extraction on the first key voice feature based on a second voice feature extraction mode, to obtain a second key voice feature;
performing voice feature extraction on the first key voice feature and the second key voice feature based on a third voice feature extraction mode, to obtain a third key voice feature; and
parsing the first key voice feature, the second key voice feature, and the third key voice feature, to obtain the cosine transform mask of the original noise audio data.

8. The method according to claim 7, wherein the parsing the first key voice feature, the second key voice feature, and the third key voice feature, to obtain the cosine transform mask of the original noise audio data comprises:
parsing the third key voice feature through a timing parsing layer in the voice parsing network, to obtain timing information of the original noise audio data; and
performing parsing through a decoding layer in the voice parsing network based on the timing information, the first key voice feature, the second key voice feature, and the third key voice feature, to obtain the cosine transform mask of the original noise audio data.

9. The method according to claim 6, wherein the generating the target enhanced audio data by using the voice generation network based on the cosine transform mask of the original noise audio data, the frequency domain signal of the original noise audio data, and the target noise reduction strength parameter comprises:
determining an original signal-to-noise ratio of the original noise audio data by using the voice generation network based on the frequency domain signal of the original noise audio data;
generating, based on the original signal-to-noise ratio and the target noise reduction strength parameter, an enhanced signal-to-noise ratio of noise-reduced original noise audio data; and
generating the target enhanced audio data based on the enhanced signal-to-noise ratio, the cosine transform mask of the original noise audio data, and the frequency domain signal of the original noise audio data.

10. The method according to claim 7, wherein the generating the target enhanced audio data based on the enhanced signal-to-noise ratio, the cosine transform mask of the original noise audio data, and the frequency domain signal of the original noise audio data comprises:
performing noise reduction processing on the frequency domain signal of the original noise audio data based on the enhanced signal-to-noise ratio and the cosine transform mask of the original noise audio data, to obtain frequency domain enhanced audio data; and
transforming the frequency domain enhanced audio data, to obtain time domain enhanced audio data, and determining the time domain enhanced audio data as the target enhanced audio data.

11. The method according to claim 6, further comprising:
obtaining sample audio data and sample noise data, and generating sample noise audio data based on the sample audio data and the sample noise data;
obtaining a sample noise reduction strength parameter for noise reduction processing on the sample noise audio data;
generating annotated voice enhanced data based on the sample noise reduction strength parameter, the sample audio data, and the sample noise data;
performing the noise reduction processing on the sample noise audio data based on the sample noise reduction strength parameter by using an initial noise reduction processing model, to obtain predicted voice enhanced data; and
performing optimization training on the initial noise reduction processing model based on the predicted voice enhanced data and the annotated voice enhanced data, to obtain the target noise reduction processing model.

12. The method according to claim 11, wherein the performing optimization training on the initial noise reduction processing model based on the predicted voice enhanced data and the annotated voice enhanced data, to obtain the target noise reduction processing model comprises:
determining a noise reduction processing error of the initial noise reduction processing model based on the predicted voice enhanced data and the annotated voice enhanced data;
determining stability of noise data comprised in the predicted voice enhanced data based on the predicted voice enhanced data; and
adjusting a model parameter of the initial noise reduction processing model based on the noise reduction processing error and the stability, to obtain the target noise reduction processing model.

13. The method according to claim 12, wherein the adjusting a model parameter of the initial noise reduction processing model based on the noise reduction processing error and the stability, to obtain the target noise reduction processing model comprises:
determining a convergence status of the initial noise reduction processing model based on the noise reduction processing error;
adjusting the model parameter of the initial noise reduction processing model based on the noise reduction processing error in response to that the convergence status of the initial noise reduction processing model is an unconverged state, or the stability is less than a stability threshold; and
determining an adjusted initial noise reduction processing model as the target noise reduction processing model until a convergence status of the adjusted initial noise reduction processing model is a converged state and corresponding stability is greater than or equal to the stability threshold.

14. The method according to claim 11, wherein the generating annotated voice enhanced data based on the sample noise reduction strength parameter, the sample audio data, and the sample noise data comprises:
performing noise reduction processing on the sample noise data based on the sample noise reduction strength parameter, to obtain processed sample noise data; and
combining the processed sample noise data and the sample audio data, to obtain the annotated voice enhanced data.

15. An apparatus for processing audio data, comprising:
at least one memory and at least one processor, the at least one memory having a computer program stored therein, and the at least one processor, when executing the computer program, implementing operations comprising:
obtaining original noise audio data to be processed, and a target scenario parameter associated with the original noise audio data;
determining, based on the target scenario parameter, a target noise reduction strength parameter for noise reduction processing; and
performing the noise reduction processing on the original noise audio data based on the target noise reduction strength parameter, to obtain target enhanced audio data.

16. The apparatus according to claim 15, wherein the target scenario parameter is for determining an application scenario of the original noise audio data, and the determining, based on the target scenario parameter, a target noise reduction strength parameter comprises:
obtaining, based on the target scenario parameter, a quality requirement level of audio data in the application scenario; and
determining, based on the quality requirement level, the target noise reduction strength parameter.

17. The apparatus according to claim 15, wherein the target scenario parameter is for determining an collection scenario of the original noise audio data, and the determining, based on the target scenario parameter, a target noise reduction strength parameter comprises:
obtaining, based on the target scenario parameter, historical noise data in a historical time period in the collection scenario; and
determining, based on the historical noise data, the target noise reduction strength parameter.

18. The apparatus according to claim 17, wherein the determining, based on the historical noise data, the target noise reduction strength parameter comprises:
determining, from the historical noise data, a noise type and a noise change feature that correspond to noise data in the collection scenario in the historical time period; and
determining, based on the noise type and the noise change feature, the target noise reduction strength parameter.

19. The apparatus according to claim 18, wherein the noise data in the collection scenario in the historical time period corresponds to M noise types, and the determining, based on the noise type and the noise change feature, the target noise reduction strength parameter comprises:
determining, based on noise change features corresponding to the M noise types respectively, M candidate noise reduction strength parameters for the noise reduction processing; and
determining the M candidate noise reduction strength parameters as target noise reduction strength parameters; or
performing mean value calculation on the M candidate noise intensity parameters, to obtain the target noise reduction strength parameter.

20. A non-transitory computer-readable storage medium, having a computer program stored therein, the computer program, when executed by a processor, implementing operations comprising:
obtaining original noise audio data to be processed, and a target scenario parameter associated with the original noise audio data;
determining, based on the target scenario parameter, a target noise reduction strength parameter for noise reduction processing; and
performing the noise reduction processing on the original noise audio data based on the target noise reduction strength parameter, to obtain target enhanced audio data.
